(19) United States
(12) Patent Application Publication
(10) Pub. No.: US 2026/0095831 A1
(43) Pub. Date: Apr. 2, 2026

(54) SINGLE CONTROLLER INTERACTION FOR USER EQUIPMENT

(71) Applicant: QUALCOMM Incorporated, San Diego, CA (US)

(72) Inventors: Mayank BATRA, Cambridge (GB); Joel LINSKY, San Diego, CA (US); Michael WINGE, Haddenham (GB); Gajinder Singh VIJ, San Diego, CA (US)

(21) Appl. No.: 18/902,632

(22) Filed: Sep. 30, 2024

(51) Int. Cl. H04W 36/10; H04W 12/043; H04W 36/32

(52) U.S. Cl. CPC H04W 36/10; H04W 12/043; H04W 36/322

(57) ABSTRACT

Various aspects of the present disclosure generally relate to wireless communication. In some aspects, a first controller device may receive a connection request from a user equipment (UE). The first controller device may transmit, to a central device, a connection message that indicates a connection or a potential connection between the first controller device and the UE. The first controller device may receive a first handover message from the central device. The first controller device may perform a first handover of the UE to a second controller device based at least in part on the first handover message. Numerous other aspects are described.

### FIELD OF THE DISCLOSURE

Aspects of the present disclosure generally relate to wireless communication and specifically relate to techniques, apparatuses, and methods associated with a single controller, among multiple controllers, interacting with a user equipment.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network, for example a wireless local area network (WLAN), such as a Wi-Fi (for example, Institute of Electrical and Electronics Engineers (IEEE) 802.11) network, may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. “Downlink” may refer to the communication link from the AP to the station, and “uplink” may refer to the communication link from the station to the AP.

The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (for example, the communication link from the AP to the device) and uplink (for example, the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

The wireless device may communicate using a short-range wireless protocol, such as a Bluetooth® protocol and may connect and exchange information between devices and paired devices (for example, between mobile phones, computers, digital cameras, wireless headsets, speakers, keyboards, mice or other input peripherals, and similar devices).

A vehicle may provide In-Vehicle Infotainment, entertainment, Wi-Fi applications, and/or Bluetooth applications. Multiple Bluetooth controllers are expected to service connections to multiple remote devices (e.g., user devices such STAs or user equipments) with a minimum quality of service. Each Bluetooth controller is observed by a user device to be a separate Bluetooth device. If there are multiple controllers, user device connections may involve extra resources and complexity.

### SUMMARY

Some aspects described herein relate to a method of wireless communication performed by a first controller device. The method may include receiving a connection request from a user equipment (UE). The method may include transmitting, to a central device, a connection message that indicates a connection or a potential connection between the first controller device and the UE. The method may include receiving a first handover message from the central device. The method may include performing a first handover of the UE to a second controller device based at least in part on the first handover message.

Some aspects described herein relate to a method of wireless communication performed by a central device. The method may include receiving, from a first controller device, a connection message that indicates a connection or a potential connection between the first controller device and a UE. The method may include transmitting, to one or more of the first controller device or a second controller device, a handover message that indicates a handover of the UE from the first controller device to the second controller device.

Some aspects described herein relate to a method of wireless communication performed by a UE. The method may include transmitting a connection request. The method may include receiving a first message from a first controller device having a first wireless protocol address. The method may include receiving a second message from a second controller device having a second wireless protocol address, where the first wireless protocol address and the second wireless protocol address are the same address.

Some aspects described herein relate to an apparatus for wireless communication at a first controller device. The apparatus may include one or more memories and one or more processors coupled to the one or more memories. The one or more processors may be individually or collectively configured to receive a connection request from a UE. The one or more processors may be configured to transmit, to a central device, a connection message that indicates a connection or a potential connection between the first controller device and the UE. The one or more processors may be individually or collectively configured to receive a first handover message from the central device. The one or more processors may be individually or collectively configured to perform a first handover of the UE to a second controller device based at least in part on the first handover message.

Some aspects described herein relate to an apparatus for wireless communication at a central device. The apparatus may include one or more memories and one or more processors coupled to the one or more memories. The one or more processors may be individually or collectively configured to receive, from a first controller device, a connection message that indicates a connection or a potential connection between the first controller device and a UE. The one or more processors may be individually or collectively configured to transmit, to one or more of the first controller device or a second controller device, a handover message that indicates a handover of the UE from the first controller device to the second controller device.

Some aspects described herein relate to an apparatus for wireless communication at a UE. The apparatus may include one or more memories and one or more processors coupled to the one or more memories. The one or more processors may be individually or collectively configured to transmit a connection request. The one or more processors may be configured to receive a first message from a first controller device having a first wireless protocol address. The one or more processors may be individually or collectively configured to receive a second message from a second controller device having a second wireless protocol address, where the first wireless protocol address and the second wireless protocol address are a same address.

Some aspects described herein relate to a non-transitory computer-readable medium that stores a set of instructions for wireless communication by a first controller device. The set of instructions, when executed by one or more processors of the first controller device, may cause the first controller device to receive a connection request from a UE. The set of instructions, when executed by one or more processors of the first controller device, may cause the first controller device to transmit, to a central device, a connection message that indicates a connection or a potential connection between the first controller device and the UE. The set of instructions, when executed by one or more processors of the first controller device, may cause the first controller device to receive a first handover message from the central device. The set of instructions, when executed by one or more processors of the first controller device, may cause the first controller device to perform a first handover of the UE to a second controller device based at least in part on the first handover message.

Some aspects described herein relate to a non-transitory computer-readable medium that stores a set of instructions for wireless communication by a central device. The set of instructions, when executed by one or more processors of the central device, may cause the central device to receive, from a first controller device, a connection message that indicates a connection or a potential connection between the first controller device and a UE. The set of instructions, when executed by one or more processors of the central device, may cause the central device to transmit, to one or more of the first controller device or a second controller device, a handover message that indicates a handover of the UE from the first controller device to the second controller device.

Some aspects described herein relate to a non-transitory computer-readable medium that stores a set of instructions for wireless communication by a UE. The set of instructions, when executed by one or more processors of the UE, may cause the UE to transmit a connection request. The set of instructions, when executed by one or more processors of the UE, may cause the UE to receive a first message from a first controller device having a first wireless protocol address. The set of instructions, when executed by one or more processors of the UE, may cause the UE to receive a second message from a second controller device having a second wireless protocol address, where the first wireless protocol address and the second wireless protocol address are a same address.

Some aspects described herein relate to an apparatus for wireless communication. The apparatus may include means for receiving a connection request from a UE. The apparatus may include means for transmitting, to a central device, a connection message that indicates a connection or a potential connection between the first controller device and the UE. The apparatus may include means for receiving a first handover message from the central device. The apparatus may include means for performing a first handover of the UE to a second controller device based at least in part on the first handover message.

Some aspects described herein relate to an apparatus for wireless communication. The apparatus may include means for receiving, from a first controller device, a connection message that indicates a connection or a potential connection between the first controller device and a UE. The apparatus may include means for transmitting, to one or more of the first controller device or a second controller device, a handover message that indicates a handover of the UE from the first controller device to the second controller device.

Some aspects described herein relate to an apparatus for wireless communication. The apparatus may include means for transmitting a connection request. The apparatus may include means for receiving a first message from a first controller device having a first wireless protocol address. The apparatus may include means for receiving a second message from a second controller device having a second wireless protocol address, where the first wireless protocol address and the second wireless protocol address are a same address.

Aspects generally include a method, apparatus, system, computer program product, non-transitory computer-readable medium, an access point (AP), a station (STA), a mobile device, a peripheral device, an audio device, UE, base station, network entity, network node, wireless communication device, and/or processing system as substantially described herein with reference to and as illustrated by the drawings and specification.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (for example, end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (for example, hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 shows a wireless communication network, in accordance with the present disclosure.

FIG. 2 illustrates an example of a wireless communication network that supports low-latency parameter updates for extended personal audio networks in accordance with the present disclosure.

FIG. 3 is a diagram illustrating an example of a wireless communication device, in accordance with the present disclosure.

FIG. 4 is a diagram illustrating an example of a system with multiple controllers, in accordance with the present disclosure.

FIG. 5 is a diagram illustrating an example of initialization, in accordance with the present disclosure.

FIGS. 6A-6D are diagrams illustrating an example of role switching, in accordance with the present disclosure.

FIG. 7 is a diagram illustrating an example of a freed address, in accordance with the present disclosure.

FIG. 8 is a diagram illustrating an example of an outgoing connection, in accordance with the present disclosure.

FIGS. 9A and 9B are diagrams illustrating examples of an incoming connection, in accordance with the present disclosure.

FIGS. 10A-10C are diagrams illustrating examples of pairing and key management, in accordance with the present disclosure.

FIGS. 11A and 11B are diagrams illustrating examples of inquiry scanning, in accordance with the present disclosure.

FIG. 12 is a diagram illustrating an example of initialization for Bluetooth Low Energy (LE), in accordance with the present disclosure.

FIG. 13 is a diagram illustrating an example of an outgoing connection, in accordance with the present disclosure.

FIGS. 14A and 14B are diagrams illustrating examples of an incoming connection, in accordance with the present disclosure.

FIG. 15 is a diagram illustrating an example of scanning, in accordance with the present disclosure.

FIG. 16 is a diagram illustrating an example of non-connectable advertising, in accordance with the present disclosure.

FIGS. 17A-17B are diagrams illustrating examples of pairing and key management in LE, in accordance with the present disclosure.

FIGS. 18A and 18B are diagrams illustrating an example of a central connection manager (CCM) managed handover, in accordance with the present disclosure.

FIGS. 19A-19C are diagrams illustrating an example of a CCM assisted handover, in accordance with the present disclosure.

FIG. 20 is a diagram illustrating an example process performed, for example, at a first controller device or an apparatus of a first controller device, in accordance with the present disclosure.

FIG. 21 is a diagram illustrating an example process performed, for example, at a central device (e.g., CCM) or an apparatus of a central device, in accordance with the present disclosure.

FIG. 22 is a diagram illustrating an example process performed, for example, at a UE or an apparatus of a UE, in accordance with the present disclosure.

FIG. 23 is a diagram of an example apparatus for wireless communication, in accordance with the present disclosure.

FIG. 24 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle may provide In-Vehicle Infotainment (IVI), entertainment, Wi-Fi applications, and/or Bluetooth applications. Multiple Bluetooth controllers are expected to service connections to multiple remote devices (e.g., user devices such mobile stations (STAs) or user equipments (UEs)) with a minimum quality of service. Each Bluetooth controller is observed by a user device to be a separate Bluetooth device. If there are multiple controllers, user device connections may involve extra resources and complexity. For example, user devices, such as headsets and gaming controllers, are used by the passengers in the rear seats and/or the front passenger seat. Since passengers can use any seat in the vehicle, the remote device is to be paired with all available Bluetooth controllers used by the entertainment system in the vehicle. The passenger has to ensure there is a connection to the right Bluetooth controller, depending on where the passenger is sitting in the vehicle.

Original Equipment Manufacturers (OEMs) have started to allow Bluetooth Low Energy (LE) accessories to connect to the vehicle, such as a health monitoring system, an accessory, and/or a child car seat. There is no dedicated Bluetooth controller for those connections. A user may see, on the user device, a list of Bluetooth controllers from which to choose. There could be four or more controllers, one for each seat and/or a main controller (e.g., vehicle head unit). It can be difficult for a user to decide to which Bluetooth controller the user device is to connect. The user is not aware of bandwidth constraints of a given controller and could overload the controller, impacting other use cases such as audio streaming or voice calls.

Various aspects relate generally to in-vehicle communications. Some aspects more specifically relate to a user device (e.g., UE) that is provided a single Bluetooth instance (address) in a paired list for connection or pairing, on behalf of multiple controllers. Bluetooth pairing is performed only once with the vehicle regardless of the vehicle seat and regardless of how many user devices are being used in the vehicle. In some aspects, the UE may use one set of keys (e.g., link key for basic rate (BR)/enhanced data rate (EDR), a long-term key (LTK) for Bluetooth LE, and/or a vehicle identity resolving key (VIRK)) with the vehicle. The VIRK may a single IRK used by all of the controllers over Bluetooth LE. In some aspects, the UE may see only a single Bluetooth address (BD_ADDR) that is used by all of the controllers. The Bluetooth address (e.g., vehicle Bluetooth device address (VBDA)) may be the identity address of the vehicle on a Bluetooth LE protocol. The UE device may be handed over from one controller (Bluetooth stack instance) to another controller (another Bluetooth stack instance) without disconnecting, based at least in part on a device type of the UE, a position of the UE (e.g., which seat), and/or Bluetooth bandwidth usage. Out-of-band communications may be used to exchange information about the controllers.

For example, a UE may prepare to interact with a vehicle via one of multiple controllers (vehicle controllers (VCs)). The passenger operations and controllers of the vehicle may be controlled by a central device (e.g., central connection manager (CCM)) hosted by the vehicle. The UE may transmit a connection request to a first controller of the vehicle. The first controller may receive the connection request and transmit a connection message, to the central device, that indicates a connection or a potential connection between the UE and the first controller. In some aspects, the central device may direct the first controller to handle the connection. The first controller may receive a handover message from the central device and perform a handover of the UE to the second controller based at least in part on the handover message. The second controller may handle the connection with the UE without the UE having any information about the handover or which controller is handling the connection. The central device may select the second controller to handle the connection based at least in part on the second controller having more available bandwidth than the first controller.

Particular aspects of the subject matter described in this disclosure can be implemented to realize one or more of the following potential advantages. By handling the connection on behalf of multiple controllers such that the UE is only aware of a single Bluetooth instance and a single Bluetooth address, the first controller may work with the central device and the second controller to simplify the connection procedure for the UE. As a result, the UE may reduce connection latency and conserve signaling resources and processing resources of the UE.

Several aspects of wireless communication networks will now be presented with reference to various apparatuses and techniques. These apparatuses and techniques will be described in the following detailed description and illustrated in the accompanying drawings by various blocks, modules, components, circuits, steps, processes, and/or algorithms, among other examples (collectively referred to as “elements”). These elements may be implemented using hardware, software, or combinations thereof. Whether such elements are implemented as hardware or software depends upon the particular application and design constraints imposed on the overall system.

In some wireless communication networks, a wireless communication device (WCD) may support applications associated with low-latency or lossless audio to one or more other devices, such as one or more personal audio devices. For example, a wireless communication device may support applications and use cases associated with ultra-low-latency (ULL), such as ULL gaming, or streaming lossless audio to one or more personal audio devices (for example, peripheral devices) of a user. In scenarios in which a user uses two peripheral devices, the wireless communication device may support an extended personal audio network (XPAN) via which the wireless communication device may communicate with the two peripheral devices. To meet latency or lossless criteria associated with an application or use case, XPAN devices may employ a target wake time (TWT) technique for communication between the wireless communication device and the peripheral devices. In some systems, the peripheral devices and the wireless communication device may exchange one or more Bluetooth (BT) messages and implement a complete TWT teardown between the wireless communication device and each of the peripheral devices. Such an exchange of Bluetooth messages and TWT teardown may introduce too much latency for some applications, such as ULL gaming or streaming lossless audio applications.

In some examples, a wireless communication device (WCD), which may be a handset or an access point (AP) (for example, a soft AP (SAP)), and a set of peripheral devices (for example, earbuds or audio devices) may use downlink audio data packets to carry updated TWT parameters or any other XPAN-related parameters that the wireless communication device and the peripheral devices may indicate via wireless signaling. Additionally, or alternatively, the wireless communication device may embed a set of updated parameters in a padding section of an audio data packet and may transmit the audio data packet to the peripheral devices. The peripheral devices may each acknowledge the audio data packet transmitted by the wireless communication device, and the wireless communication device may communicate in accordance with the updated parameters based on receiving acknowledgements from each of the peripheral devices.

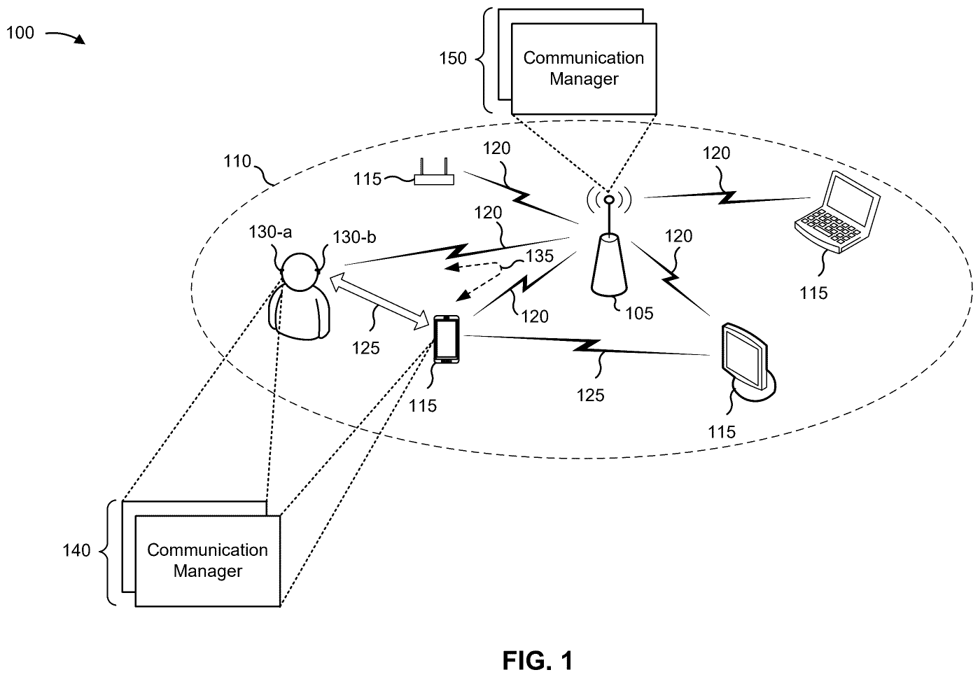

FIG. 1 shows a wireless communication network 100, in accordance with the present disclosure. The wireless communication network 100 may be a wireless local area network (WLAN) or a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include a central device 105 (e.g., AP, Bluetooth network entity) and multiple associated devices 115 (such as stations (STAs) or SAPs). The devices 115 may include mobile stations, UEs, personal digital assistants (PDAs), other handheld devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and/or vehicles, among other examples.

The central device 105 and the associated devices 115 (for example, associated STAs) may represent a basic service set (BSS) or an extended service set (ESS). A BSS includes devices that communicate with each other, and an ESS may include multiple BSSs or one or more BSSs and associated wired networks. The various devices 115 in the network are able to communicate with one another through the central device 105. The central device 105 may support a coverage area 110, which may represent a basic service area (BSA) of the wireless communication network 100. An extended network station (not shown) associated with the wireless communication network 100 may be connected to a wired or wireless distribution system that may allow multiple central devices 105 to be connected in an ESS.

While only one central device 105 is shown in FIG. 1, the wireless communication network 100 can include multiple central devices 105. The central device 105 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Although not shown in FIG. 1, a device 115 may be located in the intersection of more than one coverage area 110 and may associated with more than one central device 105. A single AP and an associated set of devices 115 may be referred to as a BSS. A distribution system (not shown) may be used to connect APs in an ESS. In some cases, the coverage area 110 of an AP may be divided into sectors (also not shown). The wireless communication network 100 may include APs of different types (for example, a metropolitan area, or a home network) with varying and/or overlapping coverage areas 110. Two devices 115 may also communicate directly via a direct wireless communication link 125 regardless of whether both devices 115 are in the same coverage area 110. Examples of direct wireless communication links 120 may include Wi-Fi Direct connections, Wi-Fi Tunneled Direct Link Setup (TDLS) links, and other group connections. Devices 115 and APs may communicate according to the WLAN radio and baseband protocol for physical and medium access control (MAC) layers from IEEE 802.11 and versions including 802.11b, 802.11g, 802.11a, 802.11n, 802.11ac, 802.11ad, 802.11ah, and/or 802.11ax, among other examples. In other implementations, peer-to-peer connections or ad hoc networks may be implemented within wireless communication network 100.

In some cases, a device 115 (or an AP) may be detectable by a central AP, but not by other devices 115 in the coverage area 110 of the central AP. For example, one device 115 may be at one end of the coverage area 110 of the central AP while another device 115 may be at the other end. Thus, both devices 115 may communicate with the AP, but may not receive the transmissions of the other. This may result in colliding transmissions for the two devices 115 in a contention-based environment (for example, carrier sense multiple access with collision avoidance (CSMA/CA)) because the devices 115 may not refrain from transmitting on top of each other. A device 115 whose transmissions are not identifiable, but that is within the same coverage area 110 may be known as a hidden node. CSMA/CA may be supplemented by the exchange of a request-to-send (RTS) packet transmitted by a sending device 115 (or AP) and a clear-to-send (CTS) packet transmitted by the receiving device 115 (or AP). This may alert other devices within range of the sender and receiver not to transmit for the duration of the primary transmission. Thus, RTS and/or CTS may help mitigate a hidden node problem.

The wireless communication network 100 may include a central device 105, devices 115 (for example, which may be referred to as source devices or central devices), and paired devices 115 (for example, which may be referred to as sink devices or peripheral devices) implementing WLAN communications (for example, Wi-Fi communications) and/or Bluetooth communications. For example, devices 115 may include cell phones, UEs, STAs, mobile stations, PDAs, other handheld devices, netbooks, notebook computers, tablet computers, laptops, or some other suitable devices. Paired devices 115 may include Bluetooth-enabled devices capable of pairing with other Bluetooth-enabled devices (for example, such as devices 115), which may include wireless audio devices (for example, headsets, earbuds, speakers, earpieces, headphones), display devices (for example, televisions or computer monitors), microphones, meters, and/or valves, among other examples. As one example, the paired devices 115 may include a wireless audio device 130-a and a wireless audio device 130-b as shown by FIG. 1 (for example, wireless earbuds), and the paired devices 115 may alternatively or additionally communicate with the central device 105. In some aspects, a paired device 115 may communicate with a device 115 using the central device 105.

“Bluetooth communications” may refer to a short-range communication protocol and may be used to connect and exchange information between devices 115 and paired devices 115 (for example, between mobile phones, computers, digital cameras, wireless headsets, speakers, keyboards, mice or other input peripherals, and similar devices). Bluetooth systems (for example, aspects of wireless communication network 100) may be organized using a central-peripheral relationship employing a time-division duplex protocol having, for example, defined time slots of 625 microseconds, in which transmission alternates between the central device (for example, a device 115) and one or more peripheral devices (for example, paired devices 115). In some examples, “device” 115 may generally refer to a central device, and “paired device” 115 may refer to a peripheral device in the wireless communication network 100. Therefore, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communication network 100. Generally, “device” 115 may refer to a wireless communication device capable of wirelessly exchanging data signals with another device (for example, a paired device 115), and “paired device” 115 may refer to a device operating in a peripheral role, or to a short-range wireless communication device capable of exchanging data signals with the device 115 (for example, using Bluetooth communication protocols).

A communication link 125 may be established between two Bluetooth-enabled devices (for example, between a device 115 and a paired device 115) and may provide for communications or services (for example, according to some Bluetooth profiles). The communication link may use, for example, a Bluetooth LE audio protocol for transferring audio (point-to-point or by broadcast). The controller stack may be responsible for setting up communication links 125, such as asynchronous connection-oriented links (or asynchronous connection-oriented connections), synchronous connection-orientated (SCO) links (or SCO connections), extended synchronous connection-oriented (eSCO) links (or eSCO connections), and/or other logical transport channel links. For example, a Bluetooth connection may be an eSCO connection for voice calls (for example, which may allow for retransmission), and/or an asynchronous connection-less (ACL) connection for music streaming (for example, advanced audio distribution profile (A2DP)), among other examples. eSCO packets may be transmitted in predetermined time slots (for example, 6 Bluetooth slots each for eSCO). The regular interval between the eSCO packets may be specified when the Bluetooth link is established. The eSCO packets to/from a specific device (for example, paired device 115) are acknowledged and may be retransmitted if not acknowledged during a retransmission window. In addition, audio may be streamed between a device 115 and a paired device 115 using an ACL connection (for example, an A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (for example, providing considerably reduced power consumption and cost while maintaining a similar communication range), human interface device (HID) profile (for example, providing low latency links with low power requirements), etc.

A device 115 may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via an AP (for example, over communication links 120). The AP and the associated devices 115 may represent a BSS or an ESS. The various devices 115 in the network may be able to communicate with one another through the AP. In some cases the AP may be associated with a coverage area, which may represent a BSA.

Devices 115 and APs may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, and/or 802.11ax. In other examples, peer-to-peer connections or ad hoc networks may be implemented within wireless communication network 100, and devices may communicate with each other via communication links 120 (for example, Wi-Fi Direct connections, Wi-Fi TDLS links, peer-to-peer communication links, or other peer or group connections). An AP may be coupled to a network (such as the Internet) and may enable a device 115 to communicate via the network (or communicate with other devices 115 coupled to the AP). A device 115 may communicate with a network device bi-directionally. For example, in a WLAN, a device 115 may communicate with an associated central device 105 via downlink (for example, the communication link from the central device 105 to the device 115) and uplink (for example, the communication link from the device 115 to the central device 105).

In some examples, content, media, and/or audio, among other examples, exchanged between a device 115 and a paired device 115 may originate from a WLAN. In some examples, device 115 may receive audio from a central device 105 (for example, via WLAN communications), and the device 115 may then relay or pass the audio to the paired device 115 (for example, via Bluetooth communications and/or the central device 105). As one example, the device 115 may relay or pass the audio to the paired device 115 via the direct wireless communication link 125. Alternatively, or additionally, the device 115 may relay and/or pass the audio to the paired device via the central device 105 as shown by reference number 135. In some examples, certain types of Bluetooth communications (for example, such as high quality or high definition (HD) Bluetooth) may require enhanced quality of service. For example, in some examples, delay-sensitive Bluetooth traffic may have a higher priority than WLAN traffic.

In some examples, a wireless communication device (for example, the central device 105 and/or a device 115) may support applications associated with low-latency or lossless audio to one or more other devices, such as one or more personal audio devices. For example, a wireless communication device may support applications and use cases associated with ULL, such as ULL gaming, or streaming lossless audio to one or more personal audio devices (for example, peripheral devices) of a user or one or more headset devices (for example, AR/VR/MR/XR headset devices). In scenarios in which a user uses two or more peripheral devices (for example, a wireless audio device 130-a and a wireless audio device 130-b), the wireless communication device may support an XPAN enabling communication with the two or more peripheral devices.

To meet latency or lossless criteria associated with an application or use case, XPAN devices may employ a TWT technique for communication between the wireless communication device and the peripheral devices. Initial or default TWT parameters may be set under an expectation for ideal (for example, interference-free or approximately interference-free) conditions and may be updated in response to changing channel conditions or a changing concurrency situation at the wireless communication device. In some systems, the peripheral devices and the wireless communication device may exchange one or more Bluetooth messages and implement a complete TWT teardown between the wireless communication device and each of the peripheral devices. Such an exchange of Bluetooth messages and TWT teardown may introduce too much latency for some applications, such as ULL gaming or streaming lossless audio applications.

In some examples, a wireless communication device, which may be a device 115 (for example, a handset) or a central device 105, and a set of peripheral devices may use downlink audio data packets to carry updated TWT parameters or any other XPAN-related parameters that the wireless communication device and the peripheral devices may indicate via wireless signaling. In some examples, the wireless communication device may embed a set of updated parameters (for example, updated TWT parameters or other parameters associated with the XPAN) in one or more fields, such as one or more contributing source (CSRC) fields, of a real-time transport protocol (RTP) audio header of an audio data packet and may transmit the audio data packet to the peripheral devices. Additionally, or alternatively, the wireless communication device may embed a set of updated parameters in a padding section of an audio data packet and may transmit the audio data packet to the peripheral devices. The peripheral devices may each acknowledge the audio data packet transmitted by the wireless communication device and the wireless communication device may communicate in accordance with the updated parameters based on receiving acknowledgements from each of the peripheral devices.

In accordance with the example implementations described herein, various devices may use over-the-air transmissions to indicate updated parameters (for example, updated XPAN-related parameters, such as updated TWT parameters) via one or both of RTP audio header CSRC fields or padding fields in a payload data section. Consequently, the various devices may use a sequence of over-the-air packet transmissions to change or update a set of parameters (for example, a set of TWT parameters). For example, via audio data packet transmissions, the various devices may configure, trigger, or indicate an increase or a decrease in audio packet periodicity (for example, when TWT service interval (SI) is changed). Further, in accordance with the described techniques, such devices may avoid an explicit TWT teardown, request, and response frame exchange and may instead achieve a TWT sequence change after RTP audio header CSRC fields or a padding section indicates updated TWT parameters.

In some aspects, a UE (for example, a device 115) may include a communication manager 140. The communication manager 140 may transmit a connection request and receive a first message from a first controller device having a first wireless protocol address. The communication manager 140 may receive a second message from a second controller device having a second wireless protocol address, where the first wireless protocol address and the second wireless protocol address are a same address.

In some aspects, a controller device (for example, a central device 105) may include a communication manager 150. The communication manager 150 may receive a connection request from a UE. The communication manager 150 may transmit, to a central device (for example, a controller manager), a connection message that indicates a connection or a potential connection between the first controller device and the UE.

The controller device may receive a first handover message from the central device and perform a first handover of the UE to a second controller device based at least in part on the first handover message.

In some aspects, a central device (for example, a central device 105 operating as a controller manager) may include a communication manager 150. The communication manager 150 may receive, from a first controller device, a connection message that indicates a connection or a potential connection between the first controller device and a UE. The communication manager 150 may transmit, to the first controller device and/or a second controller device, a handover message that indicates a handover of the UE from the first controller device to the second controller device.

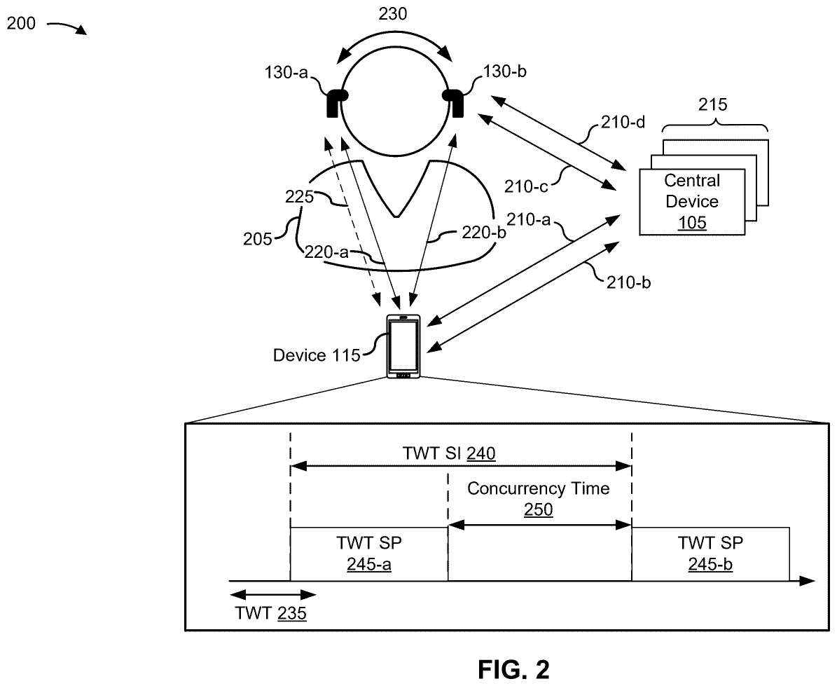

FIG. 2 illustrates an example of a wireless communication network 200 that supports low-latency parameter updates for extended personal audio networks in accordance with the present disclosure. The wireless communication network 200 may implement or be implemented to realize aspects of the wireless communication network 100. For example, the wireless communication network 200 illustrates communication between a central device 105, a device 115 (for example, a handset or handheld device), and a wireless audio device 130-a and a wireless audio device 130-b of a user 205 (for example, examples of audio devices and/or peripheral devices), which may be examples of corresponding devices as illustrated by and described with reference to FIG. 1. In some examples, the device 115, the wireless audio device 130-a, and the wireless audio device 130-b may support a signaling-based mechanism according to which the device 115 may transmit an indication of a set of updated parameters to each of the wireless audio device 130-a and the wireless audio device 130-b via one or audio data packets.

In some examples, the device 115 may communicate with the central device 105 via one or both of a link 210-a and a link 210-b, which may be examples of infrastructure links between the central device 105 and the device 115. Alternatively, or additionally, the central device 105 may communicate with the wireless audio device 130-a and/or the wireless audio device 130-b via one or both of a link 210-c and a link 210-d, respectively. In some examples, the wireless audio device 130-a and the wireless audio device 130-b may be connected to a same central device 105 as the device 115. In other aspects, the wireless audio device 130-a and the wireless audio device 130-b may be connected to a different central device 105 than the device 115. Accordingly, and as shown by reference number 215, the device 115, the wireless audio device 130-a, and/or the wireless audio device 130-b may communicate with one another via multiple APs 105. The link 210-a may be an example of a 2.4 GHz link between the central device 105 and the device 115, and the link 210-b may be an example of a 5 GHz link or a 6 GHz link between the central device 105 and the device 115. In some examples, the link 210-c and/or the link 210-d may be a 2.4 GHz link, a 5 GHz, and/or a 6 GHz link.

The device 115 may communicate wirelessly with each of the wireless audio device 130-a and the wireless audio device 130-b, where each of the wireless audio device 130-a and the wireless audio device 130-b may be associated with an XPAN of the device 115. For example, the device 115 may communicate with the wireless audio device 130-a via a link 220-a and may communicate with the wireless audio device 130-b via a link 220-b, where the link 220-a and the link 220-b may be referred to or understood as XPAN links. The link 220-a may be an example of a 5 GHz link or a 6 GHz link and the link 220-b may be an example of a 5 GHz link or a 6 GHz link. Additionally, in some examples, the device 115 may communicate with the wireless audio device 130-a, which may be an example of a primary earbud, via a communication link 225. The communication link 225 may be an example of a Bluetooth link between the device 115 and the wireless audio device 130-a. The wireless audio device 130-a and the wireless audio device 130-b, which may be an example of a secondary audio device, may communicate with each other via a link 230, which may be an example of a Bluetooth link between the wireless audio device 130-a and the wireless audio device 130-b.

The device 115 may communicate with the wireless audio device 130-a and/or the wireless audio device 130-b via one or more central devices 105. To illustrate, the device 115 may communicate with a first central device 105 via the link 210-a and/or the link 210-b. The first central device 105 may be connected to a second central device 105, and the second central device 105 may be connected to the wireless audio device 130-a and/or the wireless audio device 130-b via the link 210-c and/or the link 210-d. Accordingly, the device 115 may communicate with the wireless audio device 130-a and/or the wireless audio device 130-b based at least in part on communicating with the first central device 105, the first central device 105 communicating with the second central device 105, and the second central device 105 communicating with the wireless audio device 130-a and/or the wireless audio device 130-b. However, in other examples, the device 115, the wireless audio device 130-a, and/or the wireless audio device 130-b may be connected to a same central device 105.

In some examples, the device 115, the wireless audio device 130-a, and the wireless audio device 130-b may support or belong to an XPAN and may use the XPAN to support one or more applications or use cases, such as applications or use cases associated with latency or lossless audio constraints or criteria. For example, the device 115 may support one or more use cases of ULL gaming and streaming lossless audio to the wireless audio device 130-a and the wireless audio device 130-b (for example, personal devices of the device 115). For such applications, the device 115 may be expected to keep end-to-end latency below a relatively stringent latency target (for example, 40 milliseconds (ms) for ULL gaming). Further, the device 115 may also be tasked with handling (for example, gracefully handling without a hard disconnect and/or loss of data) a coexistence of XPAN traffic (for example, traffic to or from one or both of the wireless audio device 130-a and the wireless audio device 130-b) with other concurrency scenarios the user 205 or the system may initiate. Such other concurrency scenarios may include a scan concurrency for channel selection, STA infrastructure link concurrency for online gaming or other traffic to or from the central device 105, or neighbor aware networking (NAN) discovery and NAN data transfer, or any combination thereof.

The device 115 may have an operating condition and/or an operating specification to meet, such as a data transfer latency operating condition for various applications or use cases (for example, an ultra-low-latency constraint for a ULL gaming use case) and also facilitate coexistence between XPAN and other concurrency scenarios on the device 115. To meet the latency operating condition associated with, for example, ULL gaming, a power constraint of the wireless audio device 130-a and the wireless audio device 130-b, and/or power and concurrency constraints at the device 115, the device 115 may employ a TWT technique for the communication between the device 115 (which may act or function as an SAP) and each of the wireless audio device 130-a and wireless audio device 130-b (which may act or function as STAs). Alternatively, or additionally, the device 115 may employ one or more power saving mode time synchronization techniques as described below.

Example TWT parameters include a TWT 235, a TWT SI 240, and a TWT service period (SP) 245. A TWT 235 may indicate or be associated with a timing synchronization function (TSF) time indicating a start or beginning of a first TWT session. A TWT SI 240 may indicate a TWT interval, which may refer to a time difference between a start or beginning of two consecutive TWT sessions. A TWT SP 245 may indicate a duration during which one or both of the wireless audio device 130-a and the wireless audio device 130-b are awake during a TWT SI 240. In some aspects, a TWT SP 245 may be referred to or understood as a TWT session. As illustrated by FIG. 2, the TWT SI 240 may indicate a time difference between a TWT SP 245-a and a TWT 245-b. A remainder of time within a TWT SI 240 excluding a TWT SP 245 may be referred to or understood as a concurrency time 250 during which the device 115 may perform any operations (for example, transmission or reception) associated with a concurrency scenario at the device 115. In other words, the difference between XPAN TWT SI 240 and XPAN TWT SP 245 may be the time left for the device 115 to support other concurrencies (for example, outside of any channel switching or software overheads).

For XPAN, each of the wireless audio device 130-a and the wireless audio device 130-b (which may be examples of TWT requesting STAs) may initiate a TWT session with the device 115 (which may be an example of a TWT responding STA). Further, for low-latency use cases (for example, ULL gaming use cases), a target end-to-end latency may be relatively stringent (for example, less than or equal to approximately 40 ms), which may be tied to, associated with, or expect a Wi-Fi latency in a specific range (for example, in the sub-10 ms range). To achieve such a Wi-Fi latency, a TWT SI 240 and a TWT SP 245 may be selected or set to specific values (for example, a TWT SI 240 may be set to 4 ms with a TWT SP 245 of 2 ms). Further, for a lossless audio use case, for example, a TWT SI 240 may be set to approximately 70 ms with a TWT SP 245 of approximately 23 ms.

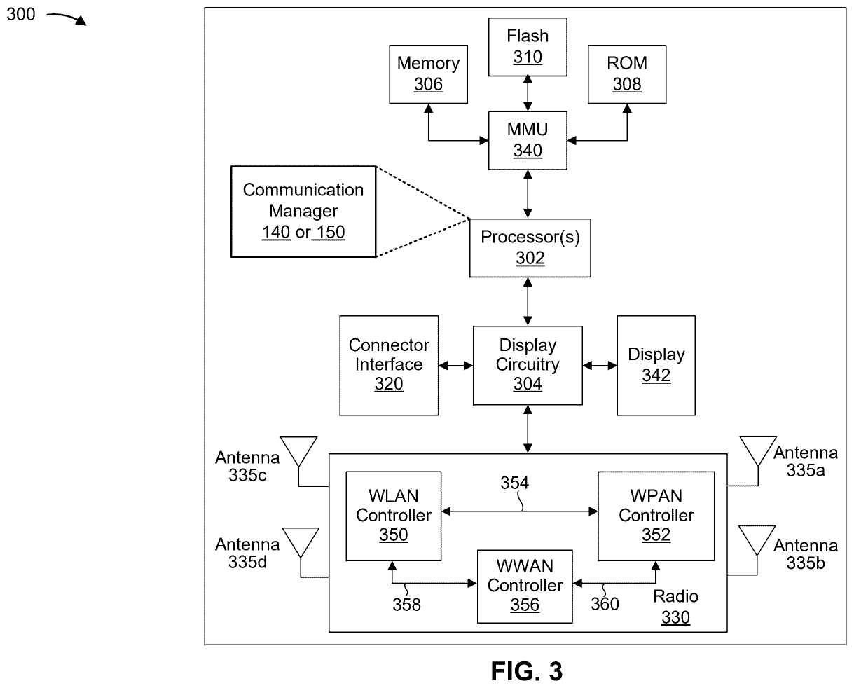

FIG. 3 is a diagram illustrating an example of a wireless communication device 300, in accordance with the present disclosure. In some aspects, the wireless communication device 300 may be an example of the central device 105, the device 115, and/or the wireless audio device 130 described above. In some examples, the central device 105, the device 115, and/or the wireless audio device 130 may include one or more wireless communication devices 300 and/or one or more components of wireless communication device 300.

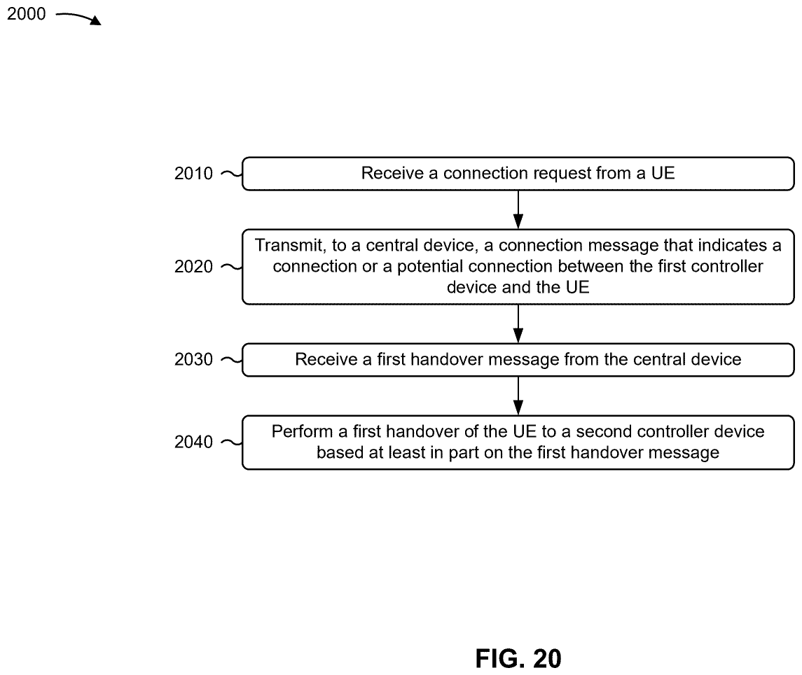

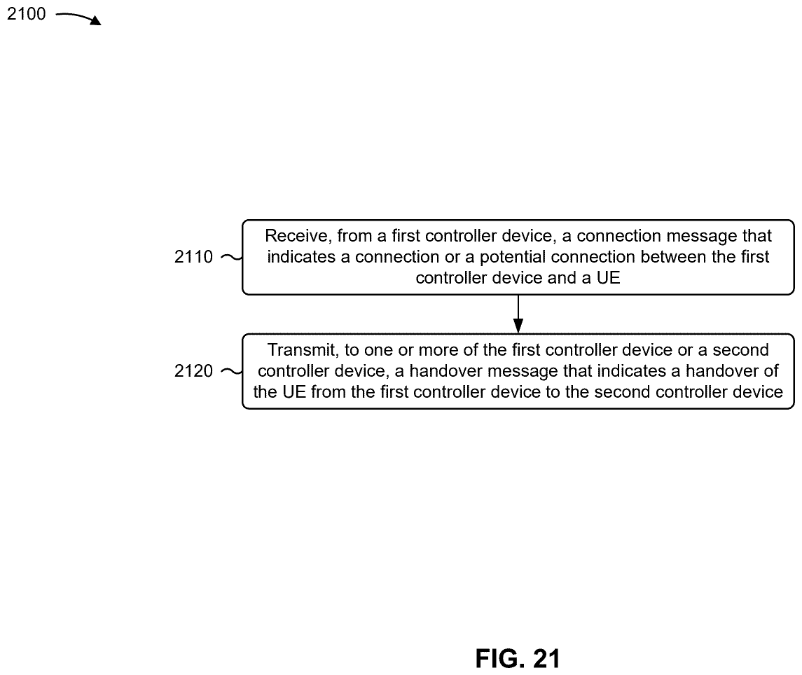

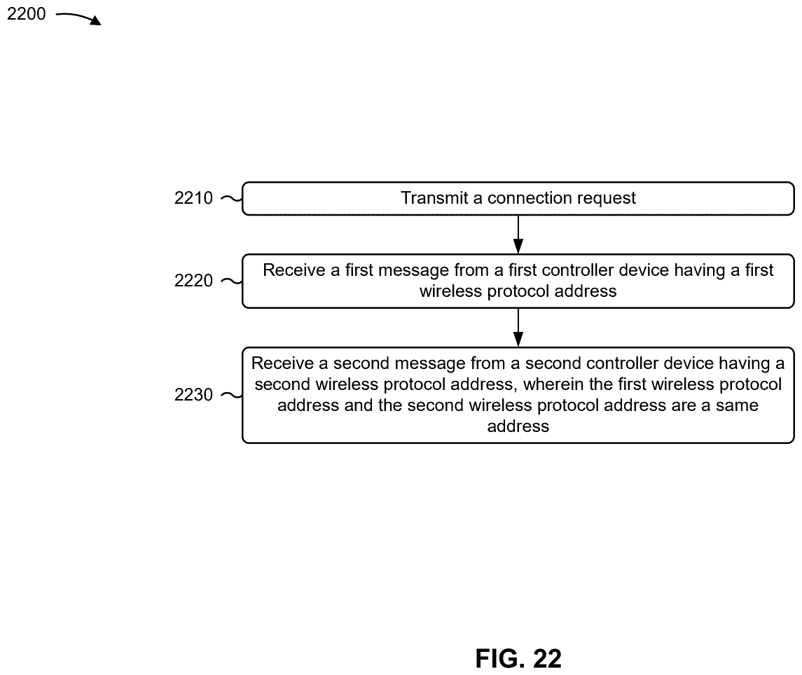

In some examples, the wireless communication device 300 is configured to perform the process 2000 of FIG. 20, process 2100 of FIG. 21, process 2200 of FIG. 22, or other processes as described herein. The wireless communication device 300 may include one or more chips, system-on-chips (SoCs), chipsets, packages, components or devices that individually or collectively constitute or comprise a processing system. The processing system may interface with other components of the wireless communication device 300, and may generally process information (such as inputs or signals) received from such other components and output information (such as outputs or signals) to such other components. In some examples, an example chip may include a processing system, a first interface to output or transmit information and a second interface to receive or obtain information. For example, the first interface may refer to an interface between the processing system of the chip and a transmission component, such that the wireless communication device 300 may transmit the information output from the chip. In such an example, the second interface may refer to an interface between the processing system of the chip and a reception component, such that the wireless communication device 300 may receive information that is passed to the processing system. In some such examples, the first interface also may obtain information, such as from the transmission component, and the second interface also may output information, such as to the reception component.

As shown in FIG. 3, the wireless communication device 300 may include processor (or “processing”) circuitry in the form of one or multiple processors, such as processor(s) 302. The processor (or “processing”) circuitry may be in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processor(s) 302 may execute program instructions for the wireless communication device 300. One or more of the processor(s) 302 may be individually or collectively configurable or configured to perform various functions or operations described herein. A group of processor(s) 302 collectively configurable or configured to perform a set of functions may include a first processor configurable or configured to perform a first function of the set and a second processor configurable or configured to perform a second function of the set, or may include the group of processors all being configured or configurable to perform the set of functions.

The wireless communication device 300 may also include a display 342 that can perform graphics processing and present information to a user. The processor(s) 302 may also be coupled to memory management unit (MMU) 340, which may be configured to receive addresses from the processor(s) 302 and translate the addresses to address locations in memory such as memory 306, read-only memory (ROM) 308, or flash memory 310 and/or to address locations in other circuits or devices, such as the display circuitry 304, radio 330, connector interface 320, and/or display 342. The MMU 340 may also be configured to perform memory protection and page table translation or set up. In some aspects, the MMU 340 may be included as a portion of the processor(s) 302. In some aspects, the wireless communication device 300 may include a communication manager (for example, communication manager 140) that controls the wireless communication device 300 or processor(s) 302 to perform the processes described herein.

In some examples, the processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”), such as the memory 306, ROM 308, and/or flash memory 310. One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The processor(s) 302 may be coupled to other circuits of the wireless communication device 300. For example, the wireless communication device 300 may include various memory types, a connector interface 320 through which the wireless communication device 300 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a WPAN subsystem, and/or a cellular subsystem (such as a Long-Term Evolution (LTE) or New Radio (NR) subsystem). The wireless communication device 300 may include multiple antennas 335a, 335b, 335c, and/or 335d for performing wireless communication with, for example, wireless communication devices in a WPAN.

The wireless communication device 300 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field-programmable gate array (FPGA), and/or an application specific integrated circuit (ASIC).

In certain aspects, the radio 330 may include separate controllers configured to control communications for various respective radio access technology (RAT) protocols. For example, as shown in FIG. 3, radio 330 may include a WLAN controller 350 that manages WLAN communications, a WPAN controller 352 that manages Bluetooth, BLE, and/or other suitable WPAN communications, and a wireless wide area network (WWAN) controller 356 that manages WWAN communications. In some aspects, the wireless communication device 300 may store and execute a WLAN software driver for controlling WLAN operations performed by the WLAN controller 350, a WPAN software driver for controlling WPAN operations performed by the WPAN controller 352, and/or a WWAN software driver for controlling WWAN operations performed by the WWAN controller 356.

In some aspects, a first coexistence interface 354 (such as a wired interface) may be used for sending information between the WLAN controller 350 and the WPAN controller 352. Additionally, or alternatively, in some aspects, a second coexistence interface 358 may be used for sending information between the WLAN controller 350 and the WWAN controller 356. Additionally, or alternatively, in some aspects, a third coexistence interface 360 may be used for sending information between the WPAN controller 352 and the WWAN controller 356. In some examples, one or more of the WLAN controller 350, the WPAN controller 352, and/or the WWAN controller 356 may be implemented as hardware, software, firmware or some combination thereof.

In some aspects, the WLAN controller 350 may be configured to communicate with a second device in a WPAN using a WLAN link using one or more, some, or all of the antennas 335a, 335b, 335c, and 335d. In other configurations, the WPAN controller 352 may be configured to communicate with at least one second device in a WPAN using one or more, some, or all of the antennas 335a, 335b, 335c, and 335d. In other configurations, the WWAN controller 356 may be configured to communicate with a second device in a WPAN using one or more, some, or all of the antennas 335a, 335b, 335c, and 335d. The WLAN controller 350, the WPAN controller 352, and/or the WWAN controller 356 may be configured to adjust a wakeup time interval and a shutdown time for the wireless communication device 300.

A short-range wireless communications protocol, such as BT, BLE, and/or basic rate (BR)/enhanced data rate (EDR), may include and/or may use one or more other communications protocols, for example, to establish and maintain communications links. In some examples, the wireless communication device 300 may establish a communications link with one or more peripheral devices, such as a wireless headset or wireless earbuds, according to at least one communications protocol for short-range wireless communications. In some aspects, the communications link may include a communications link that adheres to a protocol included and/or for use with BT, BLE, and/or BR/EDR, among other examples. In one aspect, the communications link may include an asynchronous connection-oriented logical transport, sometimes referred to as an ACL link. When operating as an ACL link, the communications link may allow the wireless communication device 300 to connect or “pair” with a peripheral device. The connection is asynchronous in that the two devices may not need to synchronize, timewise, data communications between each other to permit communication of data packets via the communications link.

In some examples, a logical link control and adaptation protocol (L2CAP) may be used within a BT protocol stack (not shown in FIG. 3). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some examples, the communications link may include an A2DP link. For example, an A2DP link may provide a point-to-point link between a source device, such as the wireless communication device 300, and a sink device, such as the wireless earbuds 130-a and 130-b. With an A2DP link, data packets including audio may be transmitted over an ACL channel, and other information (for example, for controlling the audio stream) may be transmitted over a separate control channel. The data packets may occur non-periodically.

In some examples, the communications link may support synchronous logical transport mechanisms between a source device and a peripheral device. For example, the communications link 116 may include an SCO link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience. Accordingly, in some aspects, the communications link may include an eSCO link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, the wireless communication device 300 may include means for transmitting, to one or more peripheral devices, downlink audio packets associated with a left audio channel and a right audio channel during a service period associated with a TWT SI periodicity, wherein the TWT SI periodicity is a first integer multiple of a base SI periodicity and/or means for receiving, from the one or more peripheral devices, uplink audio packets associated with a voice back channel (VBC) during a service period associated with a VBC SI periodicity, wherein the VBC SI periodicity is a second integer multiple of the base SI periodicity. In some aspects, the means for the wireless communication device 300 to perform operations described herein may include, for example, one or more of antennas 335a-335d, WPAN controller 352, WLAN controller 350, radio 330, and/or processor 302, among other examples.

The number and arrangement of components shown in FIG. 3 are provided as an example. In practice, device 300 may include additional components, fewer components, different components, or differently arranged components than those shown in FIG. 3. Additionally, or alternatively, a set of components (for example, one or more components) of device 300 may perform one or more functions described as being performed by another set of components of device 300.

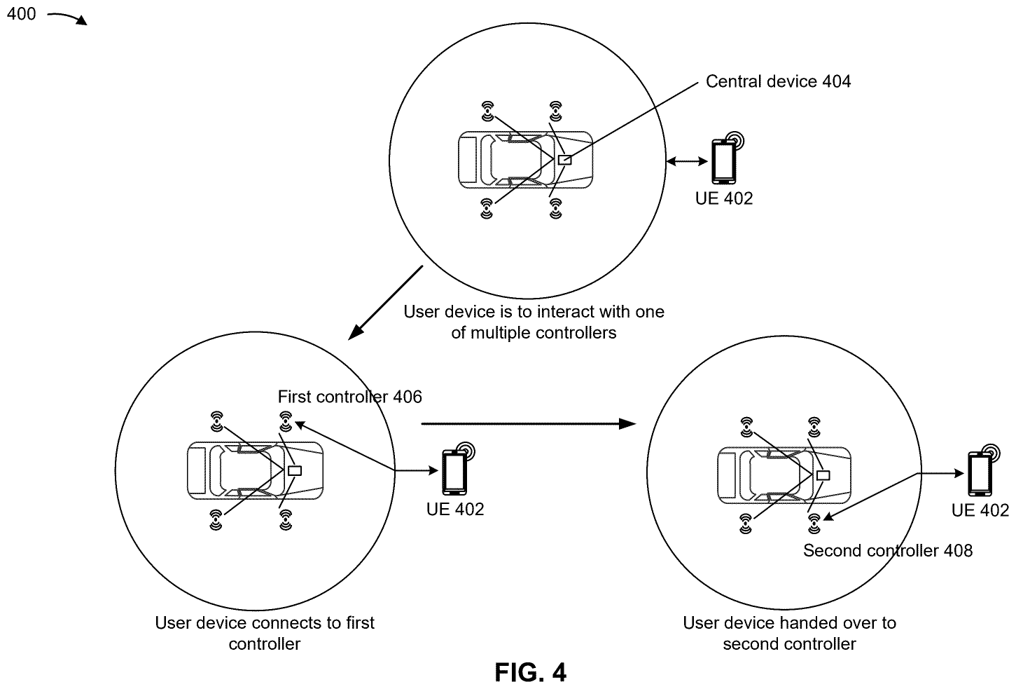

FIG. 4 is a diagram illustrating an example 400 of a system with multiple controllers, in accordance with the present disclosure.

A vehicle may provide IVI, entertainment, Wi-Fi applications, and/or Bluetooth applications. Multiple Bluetooth controllers are expected to service connections to multiple remote devices (e.g., user devices such STAs or UEs) with a minimum quality of service. Each Bluetooth controller is observed by a user device to be a separate Bluetooth device. If there are multiple controllers, user device connections may involve extra resources and complexity. For example, user devices, such as headsets and gaming controllers, are used by the passengers in the rear seats and/or the front passenger seat. Since passengers can use any seat in the vehicle, the remote device is to be paired with all available Bluetooth controllers used by the entertainment system in the vehicle. The passenger has to ensure there is a connection to the right Bluetooth controller, depending on where the passenger is sitting in the vehicle.

OEMs have started to allow Bluetooth LE accessories to connect to the vehicle, such as a health monitoring system, an accessory, and/or a child car seat. There is no dedicated Bluetooth controller for those connections. A user may see, on the user device, a list of Bluetooth controllers from which to choose. There could be four or more controllers, one for each seat and/or a main controller (e.g., vehicle head unit). It can be difficult for a user to decide to which Bluetooth controller the user device is to connect. The user is not aware of bandwidth constraints of a given controller and could overload the controller, impacting other use cases such as audio streaming or voice calls.

According to various aspects described herein, a user device (e.g., UE) may be provided a single Bluetooth instance (address) in a paired list for connection or pairing, on behalf of multiple controllers. Bluetooth pairing is performed only once with the vehicle regardless of the vehicle seat and regardless of how many user devices are being used in the vehicle. In some aspects, the UE may use one set of keys (e.g., link key for BR/EDR, an LTK for LE, and/or a VIRK) with the vehicle. In some aspects, the UE may see only a single Bluetooth address (BD_ADDR) that is used by all of the controllers. The Bluetooth address (e.g., VBDA) may be the identity address of the vehicle on a Bluetooth LE protocol. The UE device may be handed over from one controller (Bluetooth stack instance) to another controller (another Bluetooth stack instance) without disconnecting, based at least in part on a device type of the UE, a position of the UE (e.g., which seat), and/or Bluetooth bandwidth usage. Out-of-band communications may be used to exchange information about the controllers.

Example 400 shows a UE 402 that is preparing to interact with a vehicle via one of multiple controllers (e.g., VCs). The passenger operations and controllers of the vehicle may be controlled by a central device 404 (e.g., CCM) hosted by the vehicle. The CCM manages all VCs and security keys.

The UE 402 may transmit a connection request to a first controller 406 of the vehicle. The first controller 406 may receive the connection request and transmit a connection message, to the central device 404, that indicates a connection or a potential connection between the UE 402 and the first controller 406. In some aspects, the central device 404 may direct the first controller 406 to handle the connection. The first controller 406 may receive a handover message from the central device 404 and perform a handover of the UE 402 to the second controller 408 based at least in part on the handover message. The second controller 408 may handle the connection with the UE 402 without the UE 402 having any information about the handover or which controller is handling the connection. The central device 404 may select the second controller 408 to handle the connection based at least in part on the second controller 408 having more available bandwidth than the first controller 406. The central device 404 may monitor and balance controller bandwidth. By handling the connection on behalf of multiple controllers such that the UE is only aware of a single Bluetooth instance and a single Bluetooth address, the first controller may work with the central device 404 and the second controller 408 to simplify the connection procedure for the UE 402. As a result, the UE 402 may reduce connection latency and conserve signaling resources and processing resources of the UE 402.

As indicated above, FIG. 4 is provided as an example. Other examples may differ from what is described with regard to FIG. 4.

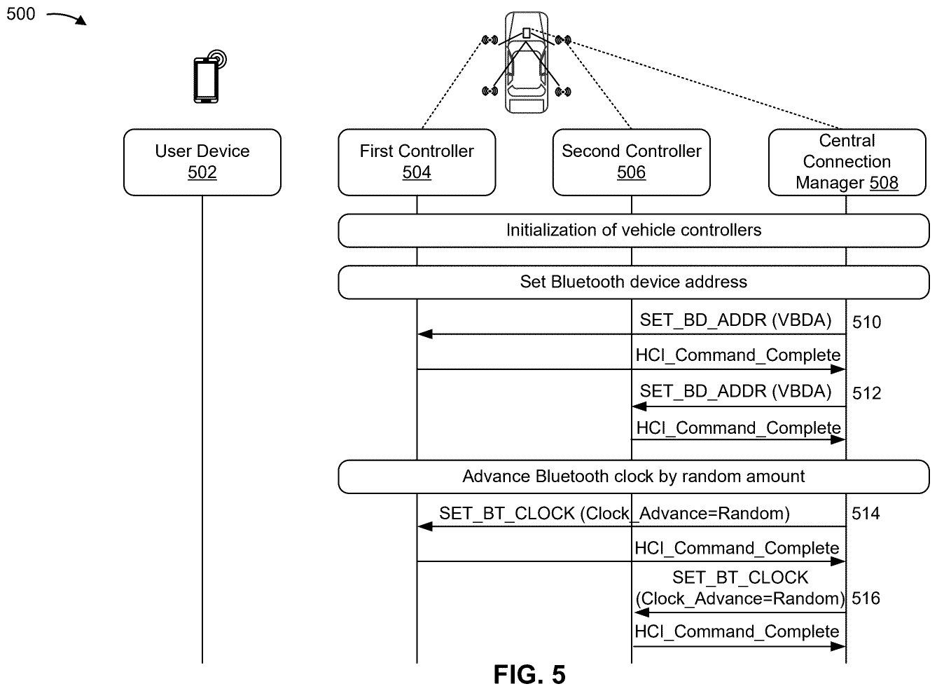

FIGS. 5-11B shows controller operations for Bluetooth BR/EDR. FIG. 5 is a diagram illustrating an example 500 of initialization, in accordance with the present disclosure. Example 500 shows a user device 502 (e.g., device 115, UE) that can connect to a first controller 504 or a second controller 506 of a vehicle. The controllers may be controlled by a CCM 508 (e.g., central device 105) hosted by the vehicle. In example 500, a UE may include a STA, a mobile device, a gaming device, a wearable device, an accessory, or other wireless device that can be used by a passenger of the vehicle. Connection requests may be within the vehicle. The CCM 508 may determine to which controller the next incoming connection should be routed and may determine which controller should be used for creating an outgoing connection. The CCM may monitor and balance Bluetooth bandwidth utilization across all of the controllers.

In some aspects, the CCM 508 may initialize the vehicle controllers. This may include setting a single Bluetooth device address for the controllers. As shown by reference number 510, the CCM 508 may transmit the address to the first controller 504. The first controller 504 may transmit a response message, such as a command complete message (e.g., HCI_Command_Complete). As shown by reference number 512, the CCM 508 may transmit the address to the second controller 506. The second controller 506 may transmit a response message.

Initialization of the controllers may also advance a Bluetooth clock by a random number between 0 and a maximum number that is allowed on the controllers. The clock is advanced by a random value so that if more than one controller has a central role of a BR/EDR piconet, then different Bluetooth clock values are used to avoid the controller arriving at the same frequency hopping sequences. As shown by reference number 514, the CCM 508 may transmit a set clock message (e.g., SET_BT_CLOCK) with a random advance value to the first controller 504, which responds with a command complete message. As shown by reference number 516, the CCM 508 may transmit a set clock message with the same random advance value to the second controller 506, which also responds with a command complete message.

As indicated above, FIG. 5 is provided as an example. Other examples may differ from what is described with regard to FIG. 5.

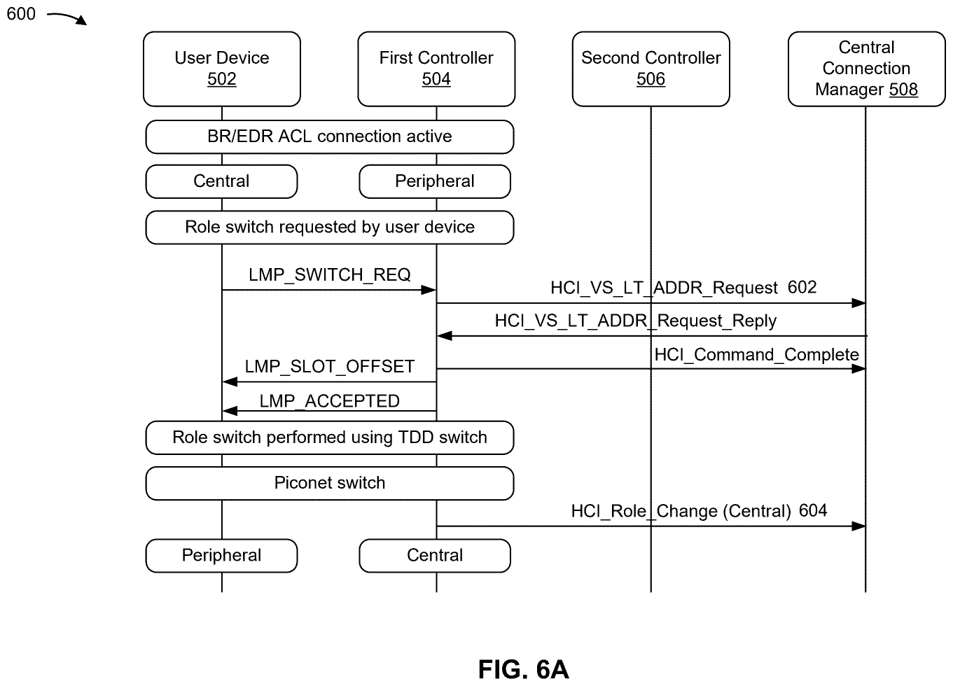

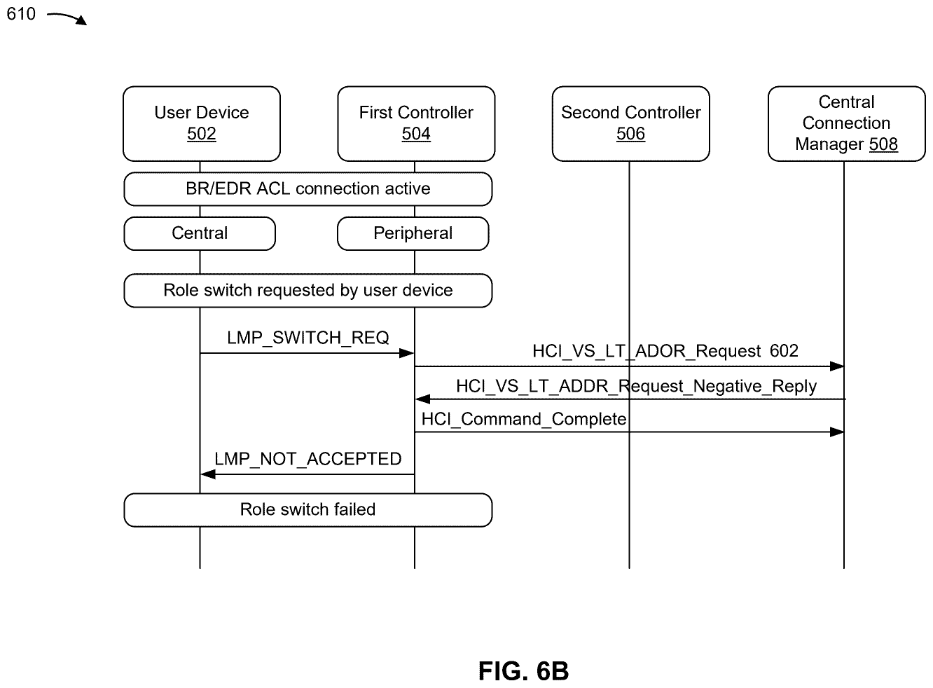

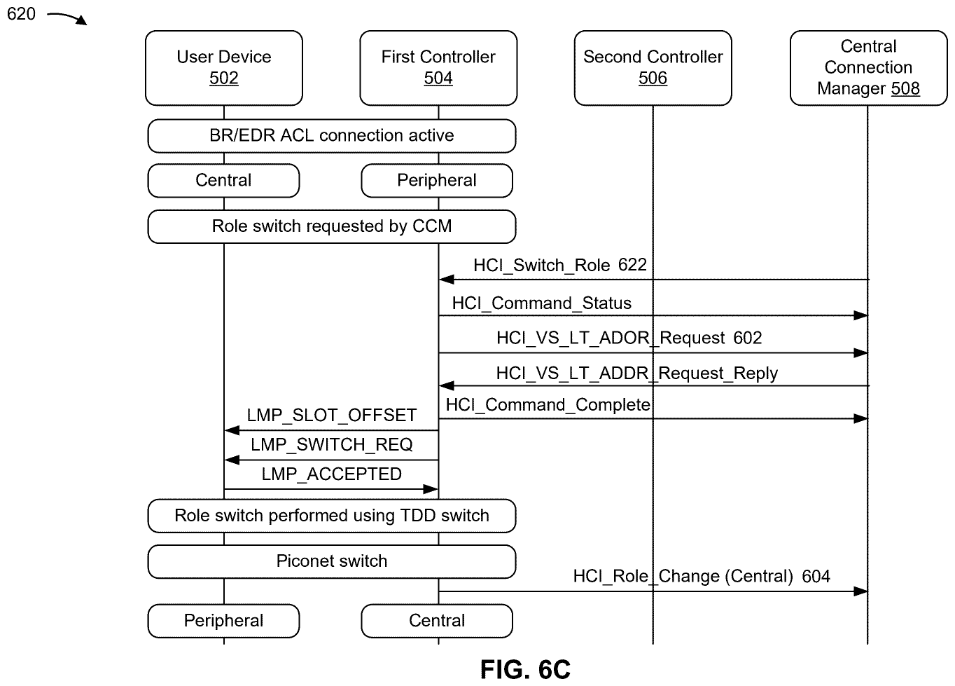

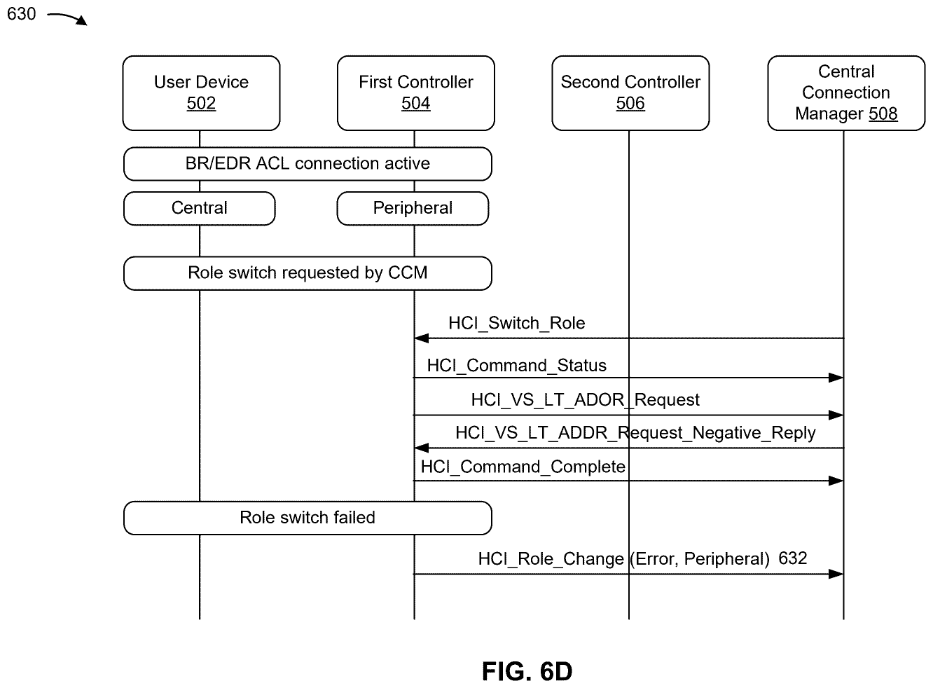

FIGS. 6A-6D are diagrams illustrating an example of role switching, in accordance with the present disclosure.

In some aspects, the CCM 508 may manage addresses. When creating a connection, a controller may request a logical transport (LT) address (e.g., LT_ADDR) from the CCM 508. LT addresses are managed by the CCM 508 such that if one more controller is in the central role, the controllers do not use the same LT address such that peripheral devices (peripheral to the central role) on one piconet do not process packets that they mistakenly receive from another piconet. Since the overall system uses a single Bluetooth address (e.g., BD_ADDR), only a certain number (e.g., up to 7 connections) may be allowed to have a central role. If additional connections need to be created, then a role switch from the central role to the peripheral role needs to be performed on one of those connections. This may include a link management protocol (LMP) switch request (e.g., LMP_SWITCH_REQ) from the user device 502 (central role) to the first controller 504 (peripheral role). If a role switch is performed (initiated either locally or remotely), the first controller 504 may request an LT_ADDR from the CCM 508 (e.g., HCI_VS_LT_ADDR_Request), as shown by reference number 602 in example 600 of FIG. 6A. In example 600, the role switch is initiated remotely. The CCM 508 may provide a reply, and the first controller 504 may reply with a command complete message. The first controller 504 may transmit an LMP slot offset and an acceptance message to the user device 502. In example 600, the user device 502 successfully switches, as shown by reference number 604, from a central role to a peripheral role with respect to the first controller 504.

If an LT_ADDR is not available, such as indicated by a negative response (e.g., HCI_VS_LT_ADDR_REQUEST_NEGATIVE_REPLY), then the role switch request is rejected. Example 610 in FIG. 6B shows that the role switch may fail.

Example 620 of FIG. 6C shows a role switch that is initiated locally. As shown by reference number 622, the CCM 508 may transmit a role switch message (e.g., HCI_Switch_Role) to the first controller 504. The first controller 504 may respond with a command status message. The first controller 504 may then proceed with requesting the LT address, as described in connection with FIG. 6A. Example 630 in FIG. 6D shows that this role switch may fail. The first controller 504 may transmit an error message to the CCM 508, as shown by reference number 632.

As indicated above, FIGS. 6A-6D provide some examples. Other examples may differ from what is described with regard to FIGS. 6A-6D.

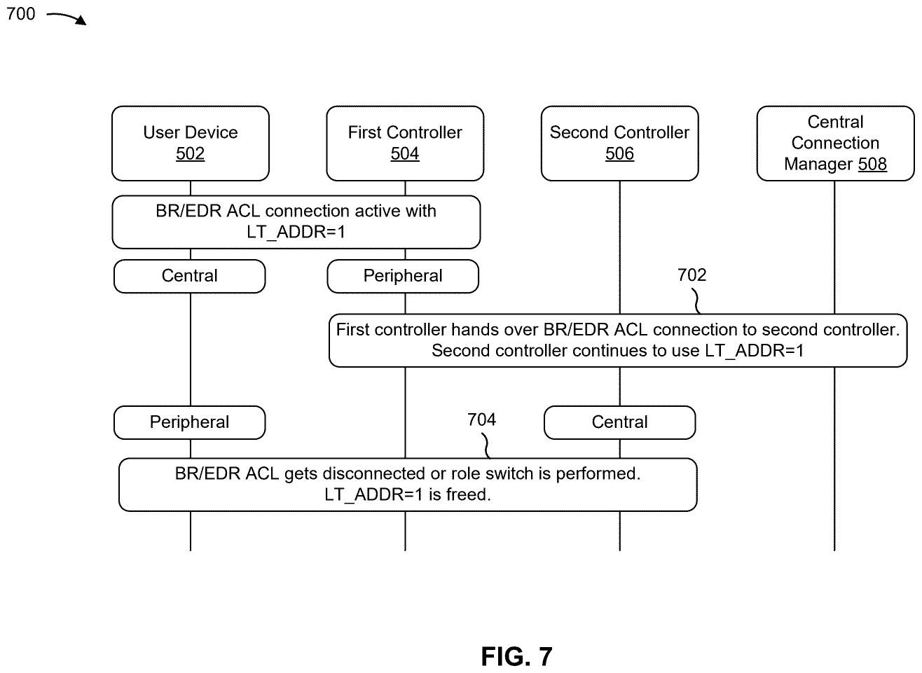

FIG. 7 is a diagram illustrating an example 700 of a freed address, in accordance with the present disclosure.

In some aspects, once a BR/EDR ACL connection has been disconnected or a role switch has been performed on the connection such that the controller becomes the peripheral role, then the LT_ADDR used on that connection is considered to be freed.

As shown by reference number 702, the first controller 504 may hand over a user device (using LT_ADDR=1) to the second controller 506. The roles may be switched. As shown by reference number 704, the BR/EDR ACL may be disconnected or a role switch may be performed. As a result, the LT_ADDR=1 is freed. The LT_ADDR=1 may be assigned to the controllers.

As indicated above, FIG. 7 is provided as an example. Other examples may differ from what is described with regard to FIG. 7.

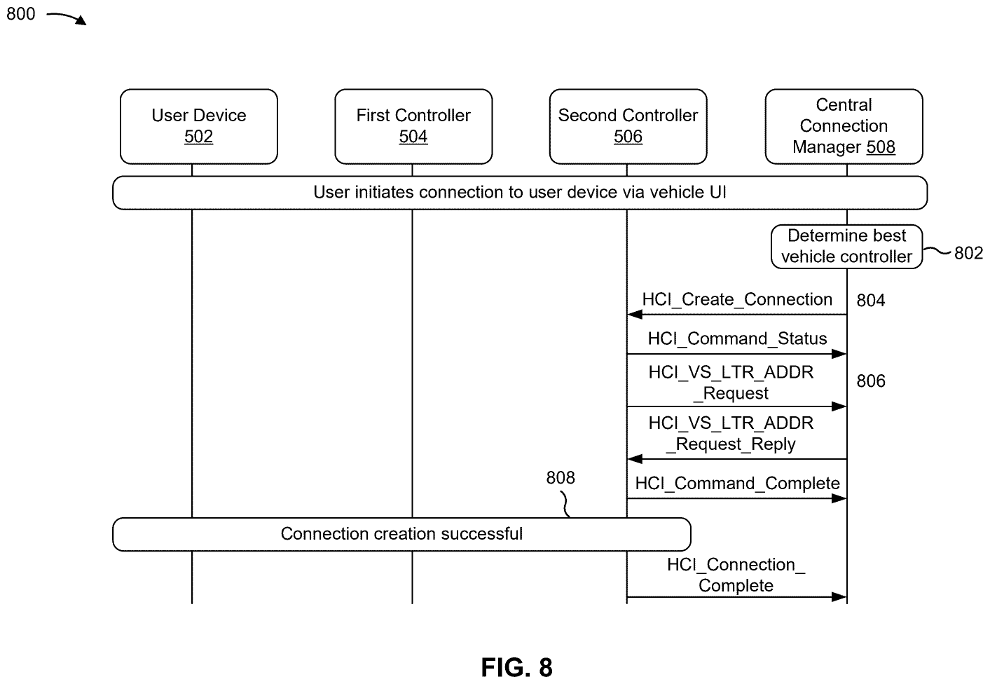

FIG. 8 is a diagram illustrating an example 800 of an outgoing connection, in accordance with the present disclosure.

In some aspects, for creating outgoing connections, the CCM 508, as shown by reference number 802, may select the best controller based at least in part on a device type of the user device 502, a seat position of a user holding the user device 502, and/or the current Bluetooth bandwidth usage on all of the controllers. As shown by reference number 804, the CCM 508 may transmit a connection message (e.g., HCI_Create_Connection). The second controller 506 may reply with a command status message. As shown by reference number 806, the second controller 506 may transmit an address request (e.g., HCI_VS_LTR_ADDR_Request). The CCM 508 may transmit a reply to the request. The second controller 506 may transmit a command complete message. As shown by reference number 808, the connection may be created successfully. The second controller 506 may transmit a connection complete message to the CCM 508.

As indicated above, FIG. 8 is provided as an example. Other examples may differ from what is described with regard to FIG. 8.

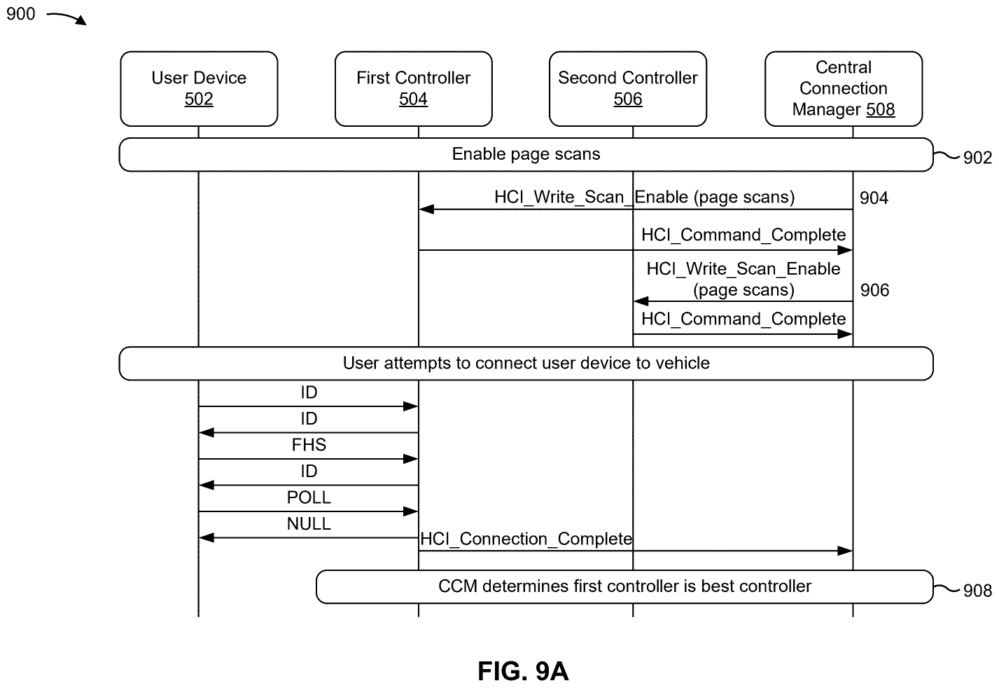

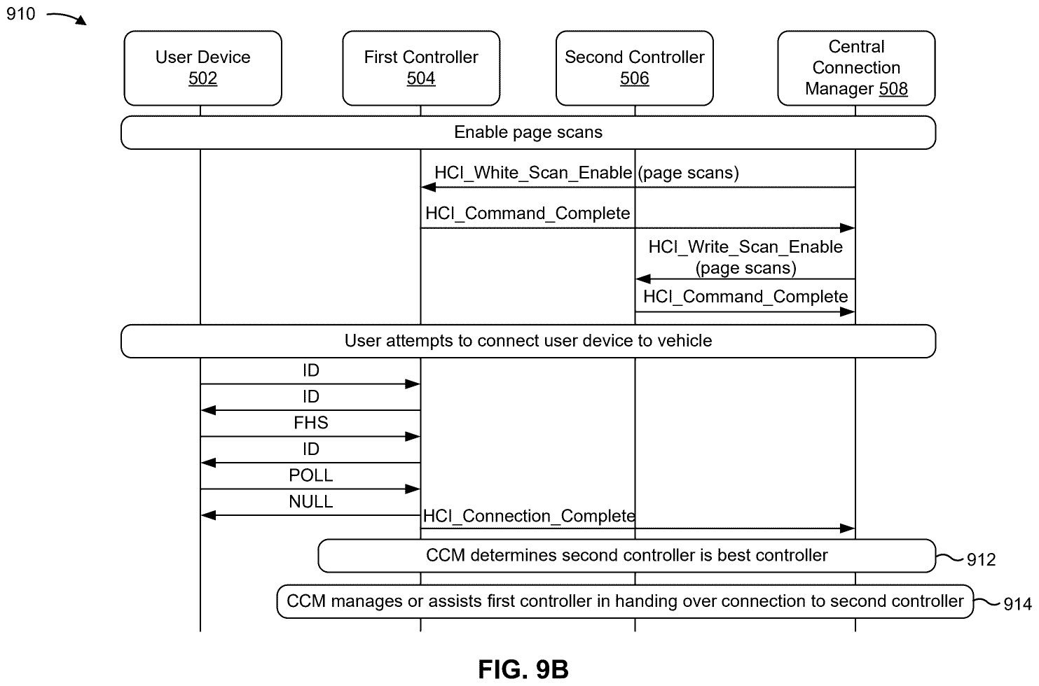

FIGS. 9A and 9B are diagrams illustrating examples of an incoming connection, in accordance with the present disclosure.

For creating incoming connections, the vehicle may perform connectable advertising. As a first option shown by example 900 of FIG. 9A, the CCM 508 may request that all of the controllers perform connectable advertising. This may include providing the CCM 508 with bandwidth information or other availability information.

In some aspects, for creating incoming connections, the CCM 508 may enable page scanning on all of the controllers that have sufficient Bluetooth bandwidth, as shown by reference number 902. The CCM 508 may request all of the controllers to perform page scans, as shown by reference numbers 904 and 906. A page scan may include a controller transmitting pages to scan for user devices. A page scan may be enabled with a write scan enable message (HCI_Write_Scan_Enable). The controllers may provide a command complete message in response.

When a user device 502 attempts to connect to the first controller 504, the first controller 504 may notify the CCM 508 of the incoming connection. If the CCM 508 determines that the first controller 504 is the most appropriate controller to accept the incoming connection, as shown by reference number 908, the CCM 508 accepts the incoming connection request. To connect to the first controller 504, the user device 502 may transmit an identifier (ID), a frequency hop synchronization (FHS) message, and a control message (e.g., POLL). The first controller 504 may transmit a connection complete message to the CCM 508.

However, in the meantime, the user device 502 may have timed out trying to establish the connection and has to retry connection creation. Since it is not guaranteed that the user device 502 connects to the same controller, the CCM 508 has to disable connectable advertising on all of other controllers temporarily (until the connection creation succeeds). Similarly, if the CCM 508 determines that the second controller 506 is the more appropriate controller to accept the incoming connection, the CCM 508 may disable connectable advertising on all of the other controllers temporarily. However, the user device 502 may see that the initial connection attempt always fails. If this failure is reported to the user device 502, there may be confusion as the user device 502 observes a second connection attempt that takes longer. If other user devices are trying to connect to the controllers on which the CCM 508 has temporarily disabled connectable advertising, then the controllers may not be able to connect. The controllers may connect to the only controller that is performing connectable advertising, which might not be the right controller.

The CCM 508 may request all of the controllers to perform connectable advertising. Example 910 of FIG. 9B shows another option for handling an incoming connection. When the user device 502 attempts to connect to the first controller 504, the first controller 504 may accept the connection and notify the CCM 508. If the CCM 508 determines that the first controller 504 is the most appropriate (“best”) controller to accept the connection, then no further action is required. The “best” controller may be the controller that can provide the highest throughput and/or lowest latency. The best controller may have the greatest available bandwidth or an available bandwidth that satisfies a bandwidth threshold (e.g., minimum bandwidth). The best controller may be the controller with the closest or least interfered position with respect to the user device 502. This determination may include using channel sounding and transmitting a message to the CCM 508 that indicates a distance and/or direction of the user device 502.

However, if the CCM 508 determines that another controller, such as the second controller 506, is the more appropriate controller to accept the connection, as shown by reference number 912, then the CCM 508 may manage or assist the first controller 504 in handing over the incoming connection to the second controller 506, as shown by reference number 914. The user device 502 is not aware of this handover taking place. As a result, the user device 502 is connected to the best controller to provide the best user experience and most efficient use of signaling resources and processing resources.

As indicated above, FIGS. 9A and 9B are provided as examples. Other examples may differ from what is described with regard to FIGS. 9A and 9B.

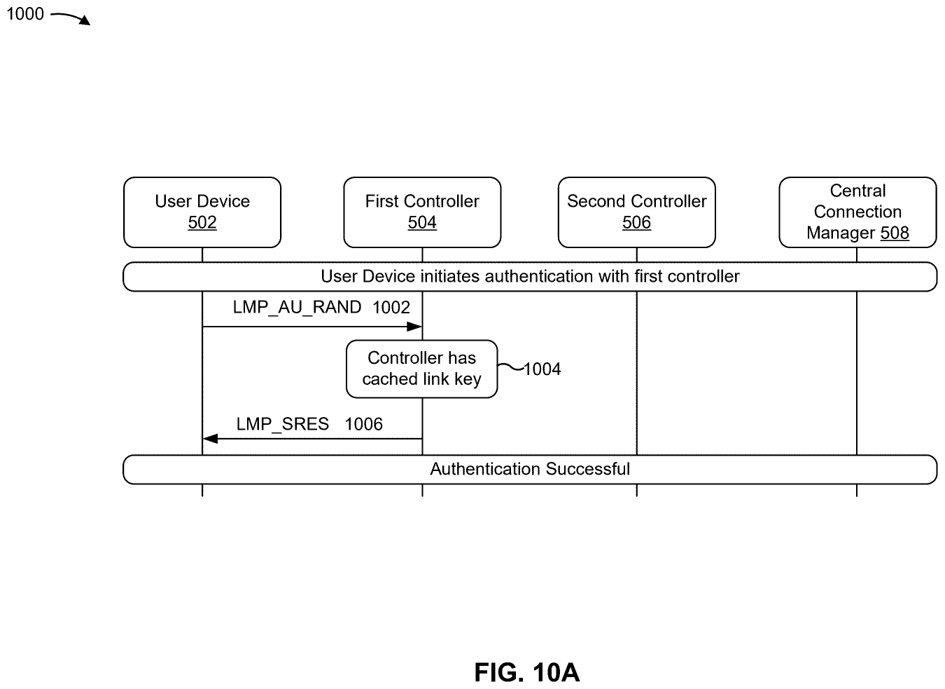

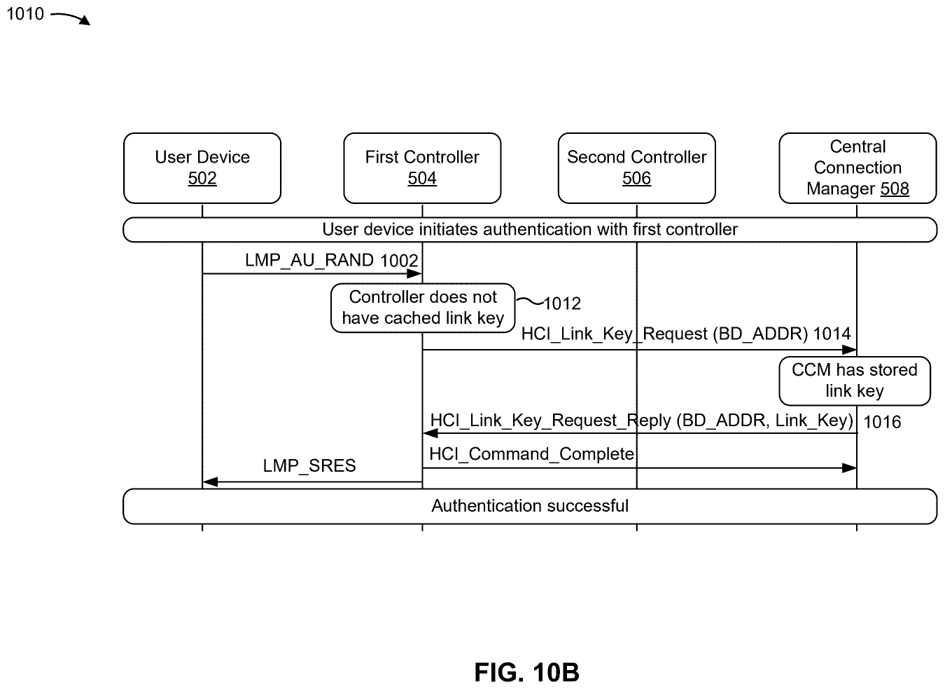

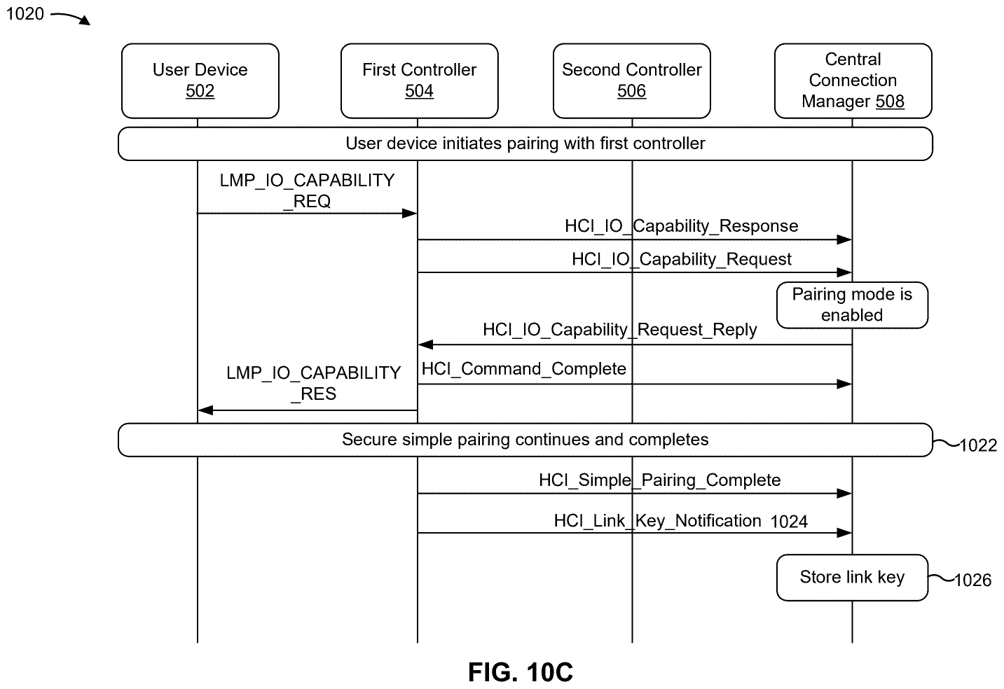

FIGS. 10A-10C are diagrams illustrating examples of pairing and key management, in accordance with the present disclosure.

When a user device attempts to authenticate a controller, there are at least three possibilities. Example 1000 of FIG. 10A shows a first possibility, when the controller being authenticated has cached the link key (key used for authentication and encryption for paired connection) and can thus complete authentication without any additional information. As shown by reference number 1002, the user device 502 may transmit an authentication message (e.g., LMP_AU_RAND) to the first controller 504. As shown by reference number 1004, the first controller 504 has cached the link key. As shown by reference number 1006, the first controller 504 may transmit a secure response (e.g., LMP_SRES). The authentication may be successful.

Example 1010 of FIG. 10B shows a second possibility, when the controller being authenticated has not cached the link key, as shown by reference number 1012.

As shown by reference number 1014, the first controller 504 may request the link key from the CCM 508 in a host controller interface (HCI) link key request message (e.g., HCI_Link_Key_Request) that identifies the Bluetooth address (BD_ADDR). The CCM 508 may have stored the link key. As shown by reference number 1016, the CCM 508 may transmit a response (e.g., HCI_Link_Key_Request_Reply) with the link key. The authentication may be successful.

Example 1020 of FIG. 10C shows a third possibility, when the controller being authenticated has not cached the link key and the CCM 508 also does not have the link key. Pairing may occur, if allowed (for example, if the user has enabled pairing mode via the vehicle user interface (UI)). The user device 502 and the first controller 504 may transmit capability messages to the CCM 508, to enable a pairing mode. Once the pairing is complete, as shown by reference number 1022, the controller may share the generated link key with the CCM 508 for storage and distribution to other controllers, as shown by reference number 1024. As shown by reference number 1026, the CCM 508 may store the link key.

As indicated above, FIGS. 10A-10C provide some examples. Other examples may differ from what is described with regard to FIGS. 10A-10C.

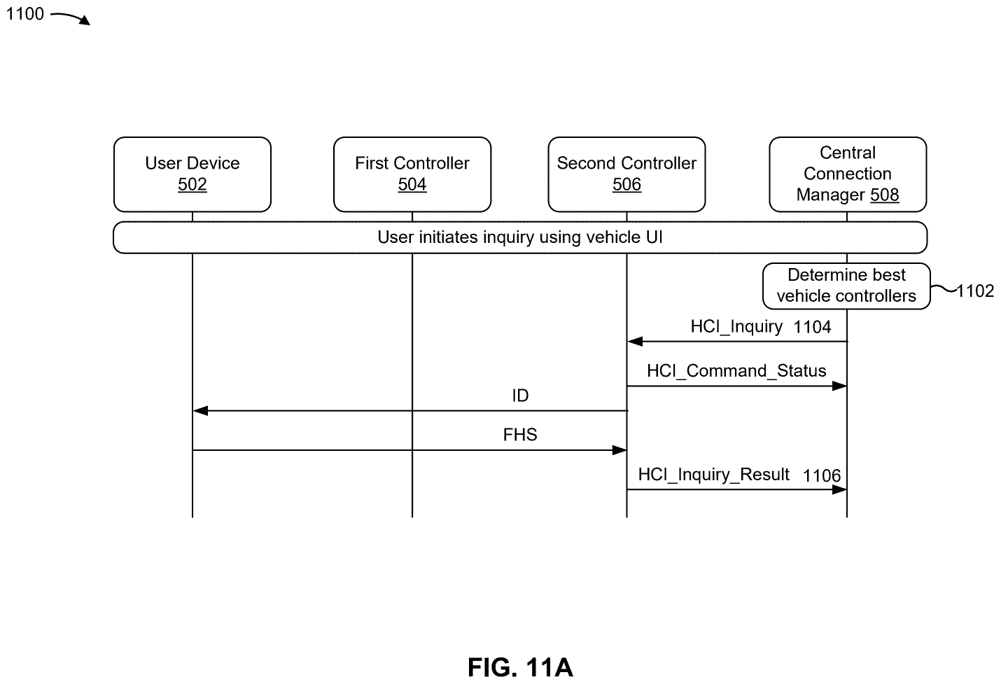

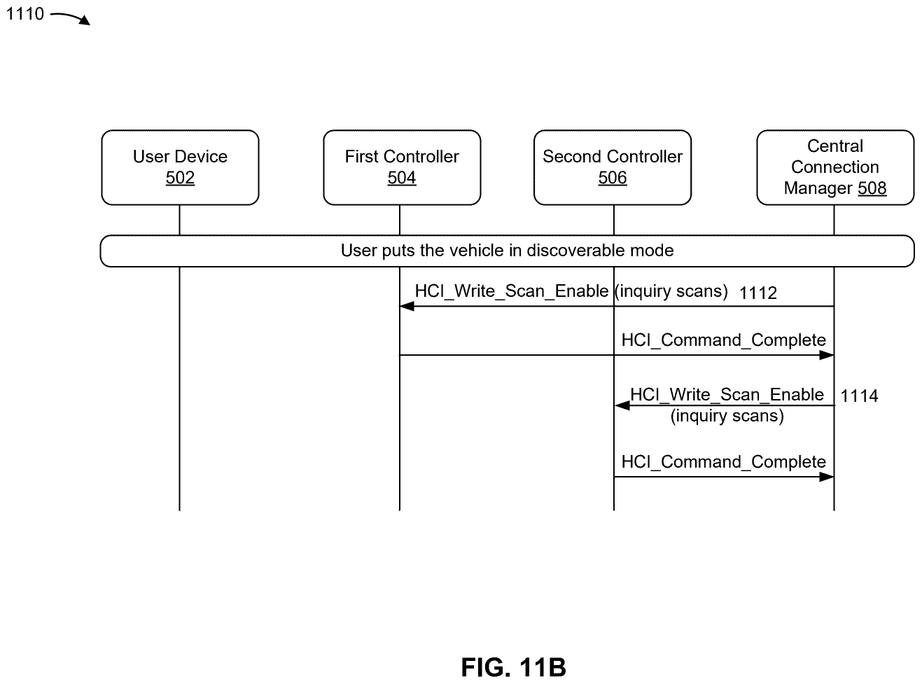

FIGS. 11A and 11B are diagrams illustrating examples of inquiry scanning, in accordance with the present disclosure.

For inquiry, the CCM 508 may select the best controllers depending on the current Bluetooth bandwidth usage on all of the controllers. Example 1100 in FIG. 11A shows that the CCM 508 may select one or more controllers, as shown by reference number 1102. As shown by reference number 1104, the CCM 508 may transmit an inquiry message to the second controller 506. The second controller 506 may transmit a command status message to the CCM 508 and obtain FHS information from the user device 502. The second controller 506 may transmit an inquiry result, as shown by reference number 1106.

Example 1110 in FIG. 11B shows that the CCM 508 may enable inquiry scans on all of the controllers that have available Bluetooth bandwidth. The user device 502 may cause the vehicle to enter a discovery mode. As shown by reference numbers 1112 and 1114, the CCM 508 may transmit inquiry messages (e.g., HCI_Write_Scan_Enable), which result in command complete messages in response. The controllers may transmit inquiry messages to user devices, to discover user devices.

In some scenarios, the user device 502 may connect to a different controller than the controller discovered during inquiry. For example, the user device 502 may discover the first controller 504 during inquiry, but during a subsequent connection creation attempt, the CCM 508 may determine that the second controller 506 is the best controller for accepting the connection. This means that the FHS information received during inquiry would be inaccurate, potentially leading to a slightly longer connection creation time.

As indicated above, FIGS. 11A-11B are provided as examples. Other examples may differ from what is described with regard to FIGS. 11A-11B.

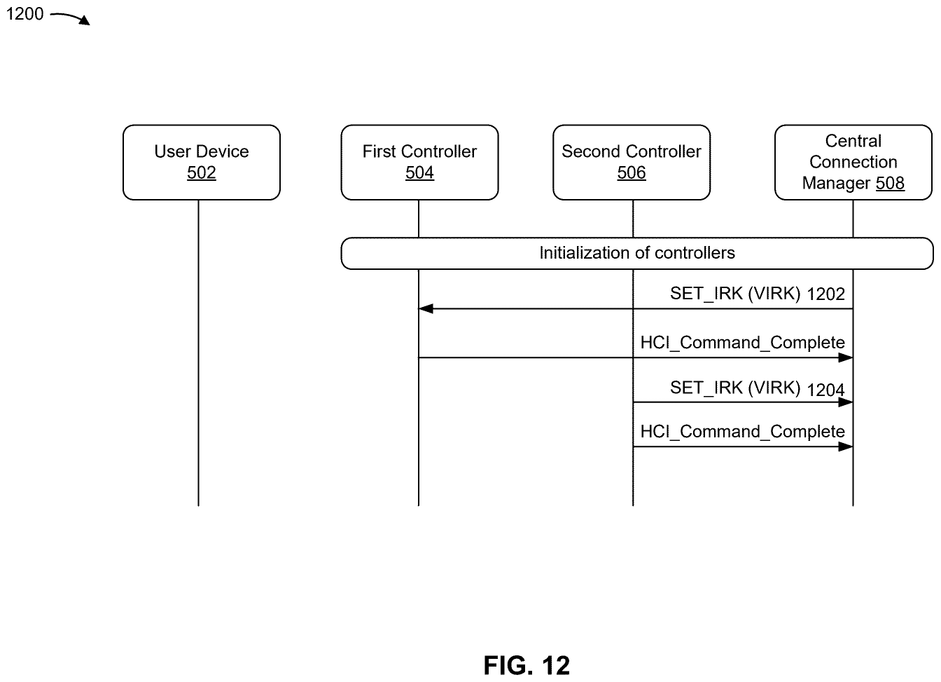

FIGS. 12-17B shows controller operations for Bluetooth LE. FIG. 12 is a diagram illustrating an example 1200 of initialization for Bluetooth LE, in accordance with the present disclosure.

In some aspects, the CCM 508 may initialize the controllers. This may include setting a single IRK for the controllers. As shown by reference number 1202, the CCM 508 may transmit a set IRK message (e.g., with a VIRK) to the first controller 504. The first controller 504 may transmit a response message, such as a command complete message (e.g., HCI_Command_Complete). As shown by reference number 1204, the CCM 508 may transmit a set IRK message (with the VIRK) to the second controller 506. The second controller 506 may transmit a response message.

As indicated above, FIG. 12 is provided as an example. Other examples may differ from what is described with regard to FIG. 12.

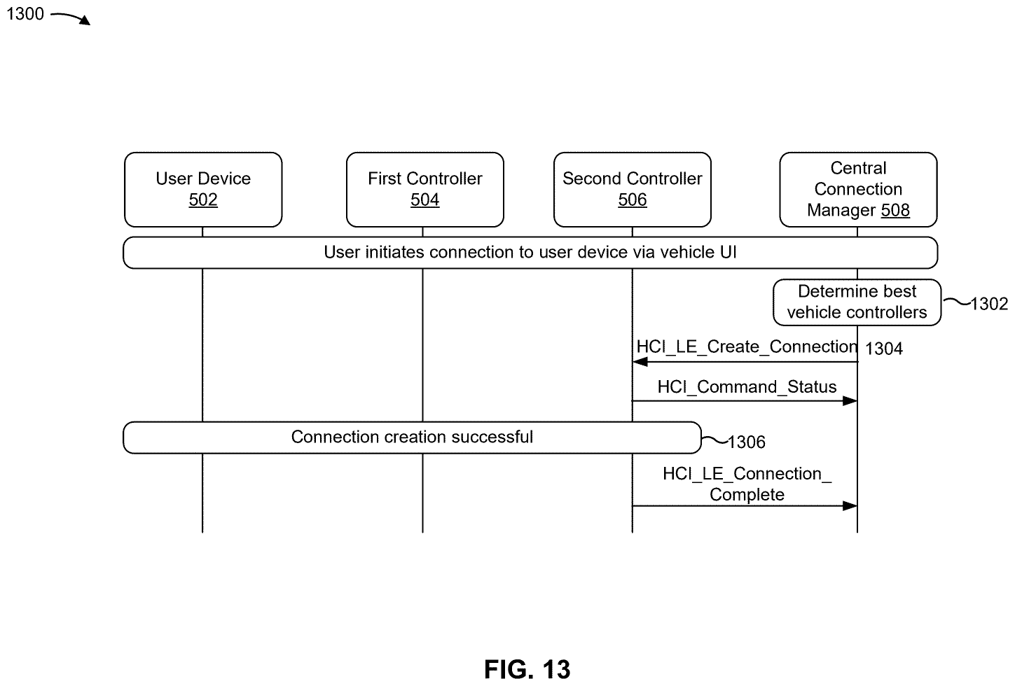

FIG. 13 is a diagram illustrating an example 1300 of an outgoing connection, in accordance with the present disclosure.

In some aspects, for creating outgoing connections, the CCM 508, as shown by reference number 1302, may select the best controller based at least in part on a device type of the remote device (user device), a seat position of a user holding the user device, and/or the current Bluetooth bandwidth usage on all of the controllers. As shown by reference number 1304, the CCM 508 may transmit a connection message (e.g., HCI_LE_Create_Connection). The second controller 506 may reply with a command status message. As shown by reference number 1306, the connection may be created successfully. The second controller 506 may transmit an LE connection complete message to the CCM 508.

As indicated above, FIG. 13 is provided as an example. Other examples may differ from what is described with regard to FIG. 13.

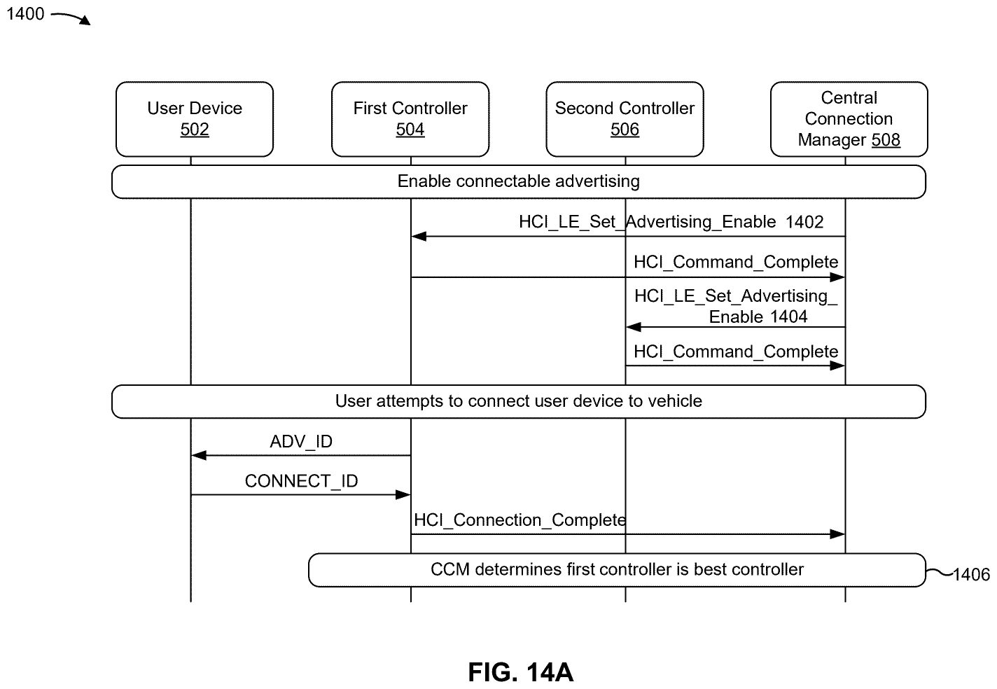

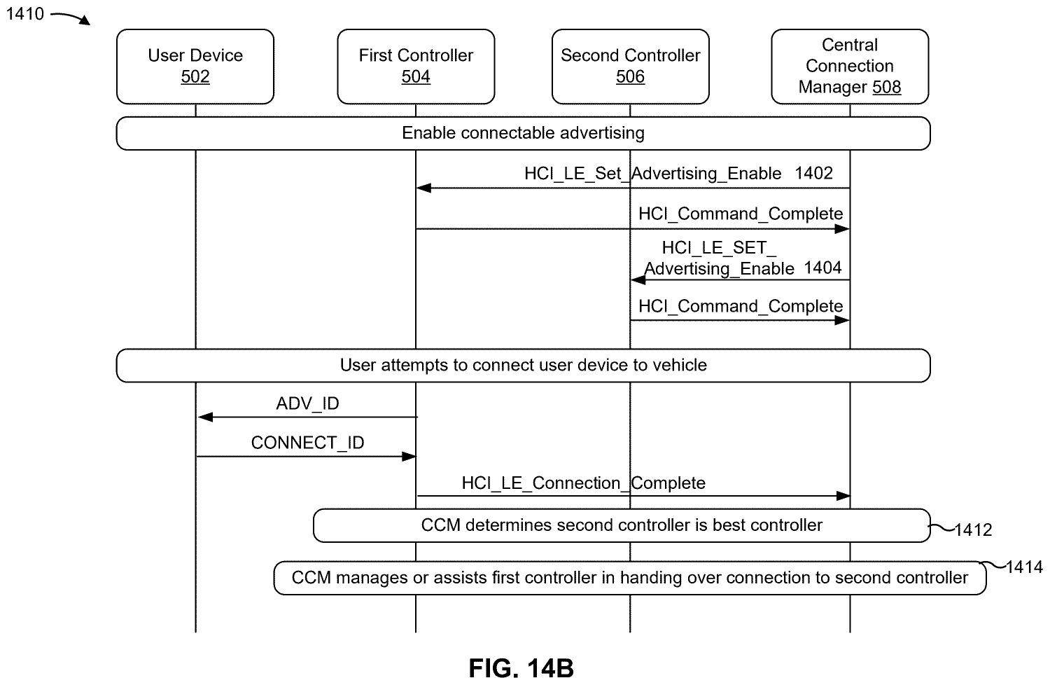

FIGS. 14A and 14B are diagrams illustrating examples of an incoming connection, in accordance with the present disclosure.

For creating incoming connections, the vehicle may perform connectable advertising. As a first option shown by example 1400 of FIG. 14A, the CCM 508 may request that all of the controllers perform connectable advertising, as shown by reference numbers 1402 and 1404. This may include providing the CCM 508 with bandwidth information or other availability information.

When a user device 502 attempts to connect to the first controller 504, the first controller 504 may notify the CCM 508 of the incoming connection. If the CCM 508 determines that the first controller 504 is the most appropriate controller to accept the incoming connection, as shown by reference number 1406, the CCM 508 may accept the incoming connection request. However, in the meantime, the user device 502 may have timed out trying to establish the connection and has to retry connection creation. Since it is not guaranteed that the user device 502 connects to the same controller, the CCM 508 has to disable connectable advertising on all of other controllers temporarily (until the connection creation succeeds). Similarly, if the CCM 508 determines that the second controller 506 is the more appropriate controller to accept the incoming connection, the CCM 508 may disable connectable advertising on all of the other controllers temporarily.

The CCM 508 may request all of the controllers to perform connectable advertising. Example 1410 of FIG. 14B shows another option for handling an incoming connection. When the user device 502 attempts to connect to the first controller 504, the first controller 504 may accept the connection and notify the CCM 508. If the CCM 508 determines that the first controller 504 is the most appropriate controller to accept the connection, then no further action is required. However, if the CCM 508 determines that another controller, such as the second controller 506, is the more appropriate controller to accept the connection, as shown by reference number 1412, then the CCM 508 may manage or assist the first controller 504 in handing over the incoming connection to the second controller 506, as shown by reference number 1414. The user device 502 is not aware of this handover taking place.

As indicated above, FIGS. 14A and 14B are provided as examples. Other examples may differ from what is described with regard to FIGS. 14A and 14B.

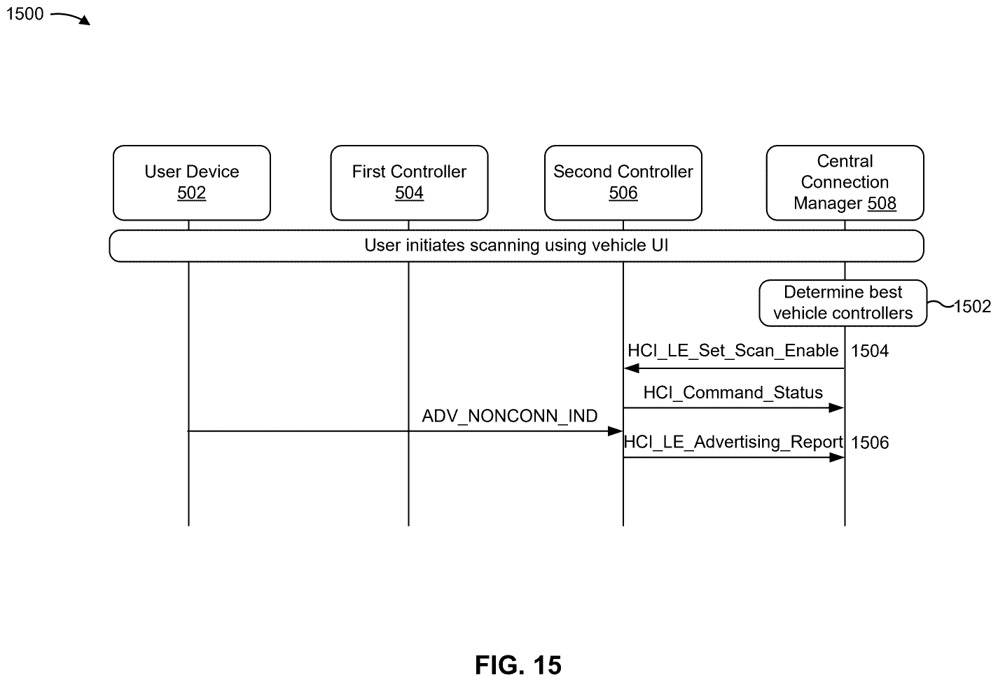

FIG. 15 is a diagram illustrating an example 1500 of scanning, in accordance with the present disclosure.

For scanning, the CCM 508 may select the best controllers, as shown by reference number 1502, based at least in part on the current Bluetooth bandwidth usage on all of the controllers. As shown by reference number 1504, if the second controller 506 is selected, the CCM 508 may transmit an enable scan message to the second controller 506. The second controller 506 may transmit a command status message. The user device 502 may broadcast advertising information without intending to immediately connect (e.g., ADV_NONCONN_IND) to a controller. The second controller 506 may receive the broadcast. As shown by reference number 1506, the second controller 506 may transmit an advertising report. Example 1100 in FIG. 11A shows that the CCM 508 may select one or more controllers.

As indicated above, FIG. 15 is provided as an example. Other examples may differ from what is described with regard to FIG. 15.

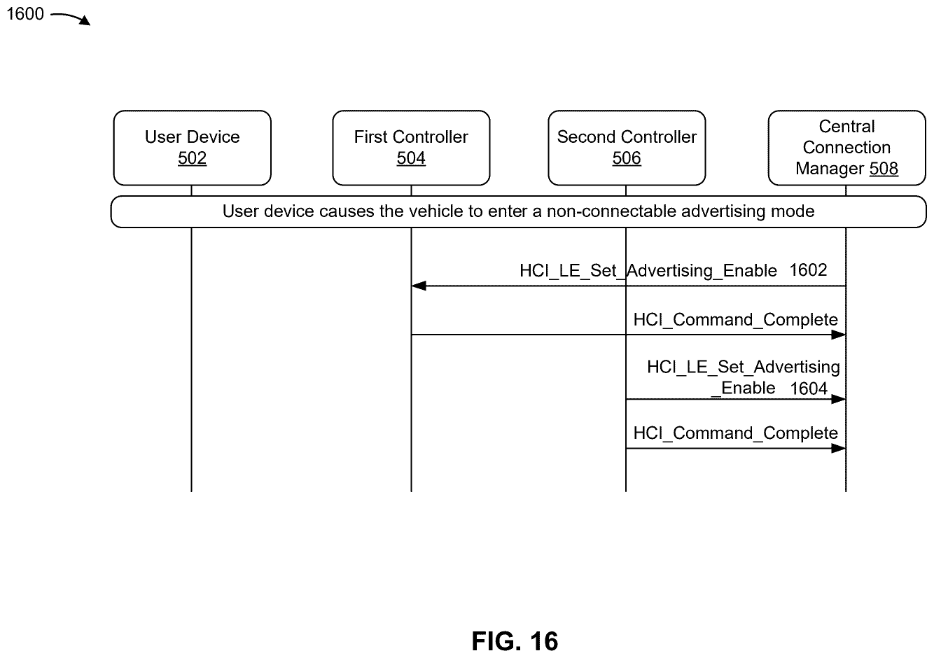

FIG. 16 is a diagram illustrating an example 1600 of non-connectable advertising, in accordance with the present disclosure.

In some aspects, the user device 502 may cause the vehicle to enter a non-connectable advertising mode. The CCM 508 may enable non-connectable advertising on all of the controllers that have available Bluetooth bandwidth. As shown by reference numbers 1602 and 1604, the CCM 508 may transmit enable advertising messages to the controllers. The CCM 508 may receive command complete messages in response. No connection is made as the CCM 508 is only collecting advertising information, which may indicate available bandwidth and/or capability information.

As indicated above, FIG. 16 is provided as an example. Other examples may differ from what is described with regard to FIG. 16.

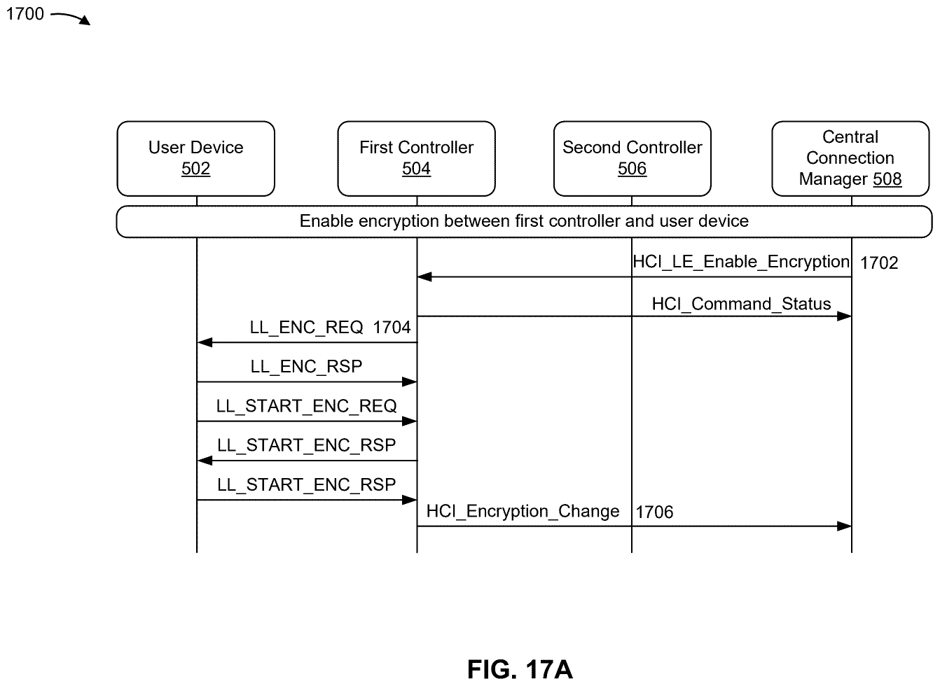

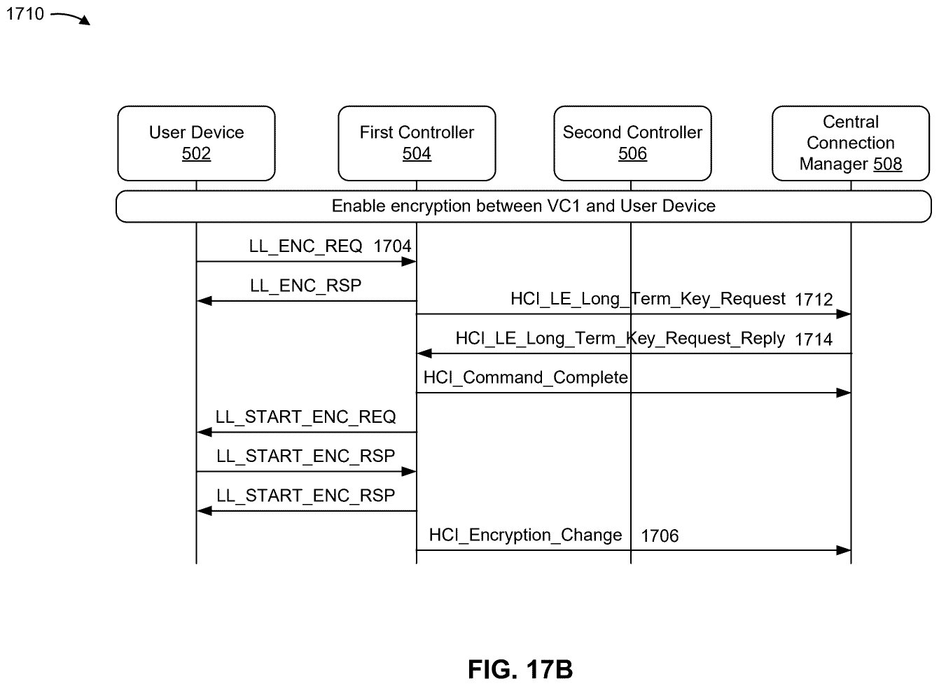

FIGS. 17A-17B are diagrams illustrating examples of pairing and key management in LE, in accordance with the present disclosure.

In Bluetooth LE, the Long Term Key (LTK) may be required to enable encryption on an ACL connection and any associated connection isolation streams (CISs). In example 1700, encryption is enabled with the first controller 504 in the central role. Example 1700 of FIG. 17A shows that if the first controller 504 is in a central role, the CCM 508 may provide the LTK to the first controller 504. As shown by reference number 1702, the CCM 508 may transmit an enable encryption message (e.g., HCI_LE_Enable_Encryption). The first controller 504 may provide a command status message in response. As shown by reference number 1704, the first controller 504 may transmit a link layer (LL) encryption request message (e.g., LL_ENC_REQ) to the user device 502. Following some further encryption messages (e.g., LL_START_ENC_REQ, response messages), the first controller 504 may transmit an encryption status message (e.g., HCI_Encryption_Change) to the CCM 508, as shown by reference number 1706.

As shown by reference number 1712 in example 1710 of FIG. 17B, if the first controller 504 is in the peripheral role, the first controller 504 may transmit a request (e.g., HCI_LE_Long_Term_Key_Request) for the LTK from the CCM 508. The CCM 508 may transmit the LTK in a response message (e.g., HCI_LE_Long_Term_Key_Request_Reply), as shown by reference number 1714. In example 1710, encryption is enabled with the first controller 504 in the peripheral role. If the CCM 508 does not have the LTK as the central role or the peripheral role, pairing can be performed between the user device 502 and the first controller 504. Since pairing is performed at the security manager layer, which is part of the host of the CCM 508, it may not matter which controller is being used.

As indicated above, FIGS. 17A-17B provide some examples. Other examples may differ from what is described with regard to FIGS. 17A-17B.

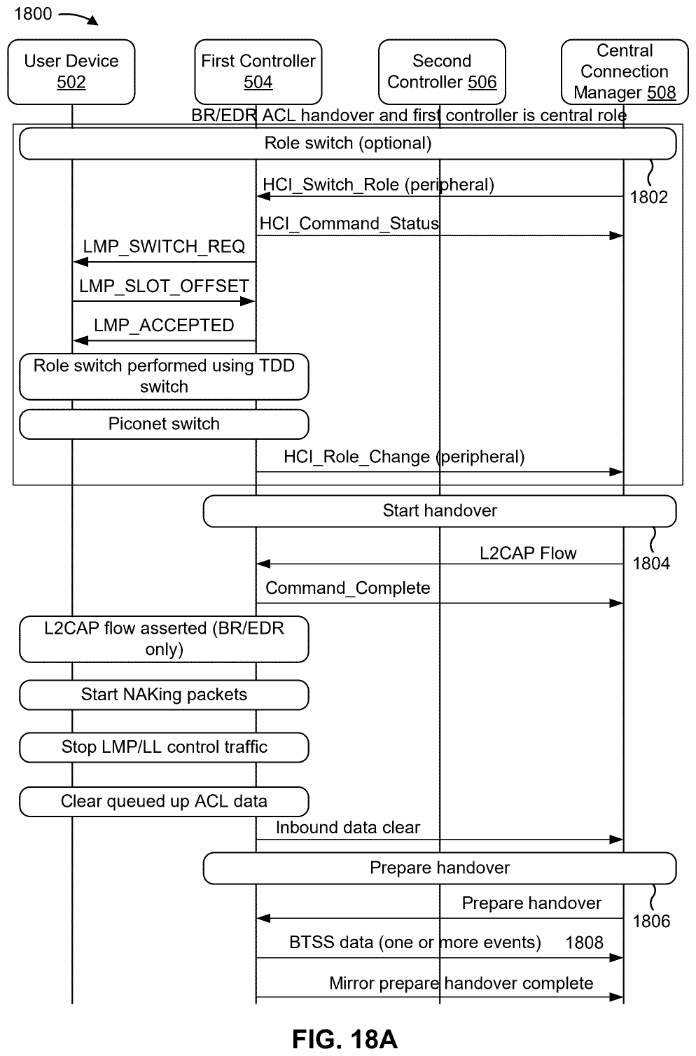

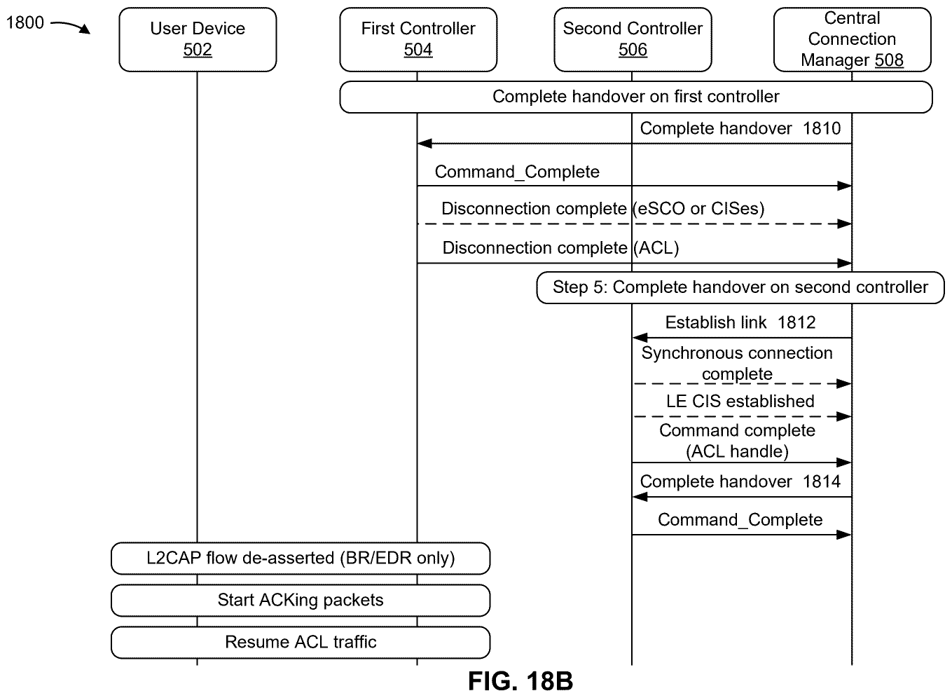

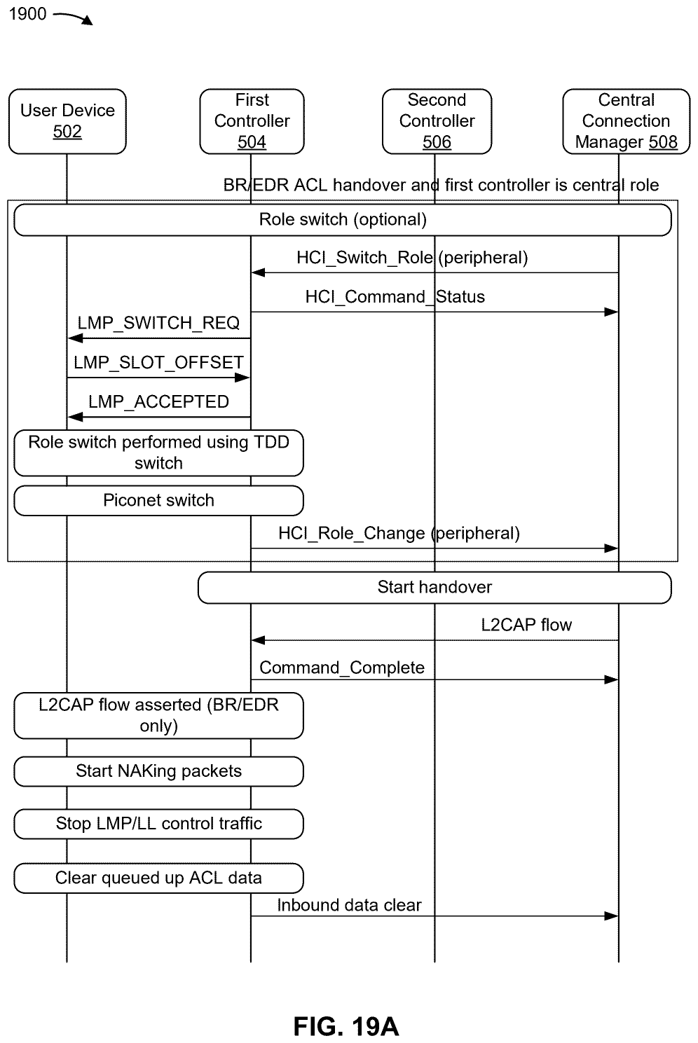

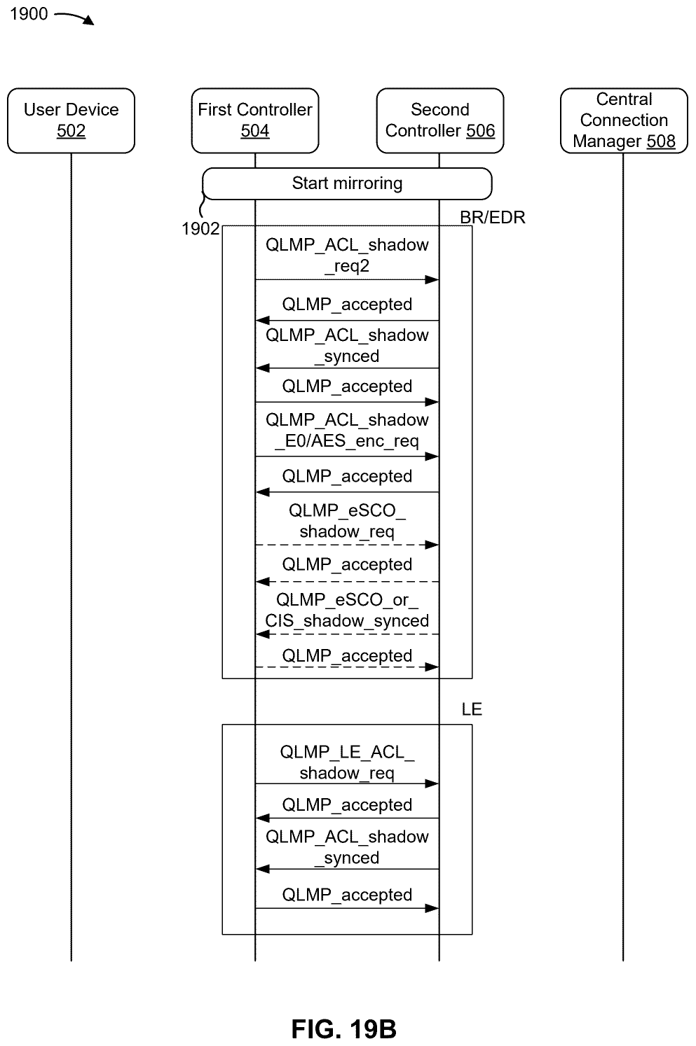

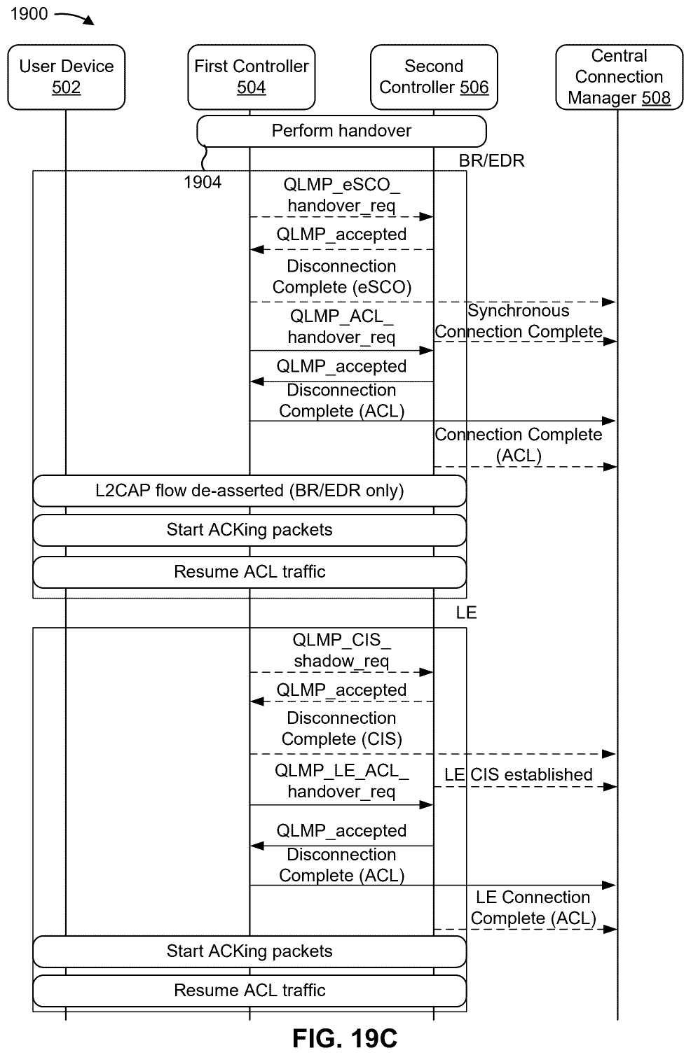

In some aspects, there are two options for handing over an LE or BR/EDR ACL (and associated connections such as CISs and eSCO) from one controller to another. In a first option, shown by FIGS. 18A and 18B, the CCM 508 manages the entire handover process. The controllers do not communicate with each other directly. In second option, shown by FIGS. 19A-19C, the CCM 508 assists with the handover. The controllers communicate with each other directly. The handover may be before or after an actual connection to the first controller 504.

FIGS. 18A and 18B are diagrams illustrating an example 1800 of a CCM managed handover, in accordance with the present disclosure.

The CCM may manage a handover of an LE or BR/EDR ACL connection and any associated connections (such as CISs and eSCO) from one controller to another controller. The controller that is handing over the connection may be the first controller 504. The other controller may be the second controller 506. Example 1800 in FIGS. 18A and 18B show the CCM managed handover of a BR/EDR or LE connection from the first controller 504 to the second controller 506.

As shown by reference number 1802, an option role switch may be performed. The first controller 504 may be in a central role, and the CCM 508 may switch to a peripheral role (BR/EDR only). After the handover is complete, the second controller 506 may request another role switch to become the central role. These role switches may be performed so that the second controller 506 can provide its own clock information to the peripheral role when the second controller 506 switches to the central role. The role switch may be performed using a time domain duplexing (TDD) switch and/or a piconet switch. That is, the second controller 506 may not need to keep maintaining the clock information of the first controller 504.

As shown by reference number 1804, the CCM 508 may start the handover. The first controller 504 may transmit a L2CAP flow message for data segmentation, multiplexing, and managing the data flow. The first controller 504 may respond with a command complete message. The first controller 504 may assert an L2CAP flow (for BR/EDR) and may start negative acknowledging (NAKing) all packets. The first controller 504 may stop LMP traffic and clear out all inbound and outbound ACL data queued up. The first controller 504 may indicate, to the CCM 508, that all inbound data has been cleared. For Bluetooth LE ACL, the first controller 504 may start NAKing all packets, stop LL control traffic, clear out inbound and outbound ACL data queued up, and inform the CCM 508.

As shown by reference number 1806, the CCM may prepare for handover with a prepare handover message to the first controller 504. As shown by reference number 1808, the first controller 504 may transmit a Bluetooth subsystem (BTSS) message to the CCM 508. The first controller 504 may provide the link manager and baseband information (for BR/EDR) or the link layer information (for LE) to the CCM 508, which may provide the information to the second controller 506.

Example 1800 continues on FIG. 18B with the handover being completed on the first controller 504. The CCM 508 completing the handover on the first controller 504 causes the first controller 504 to disconnect with the connection that is being handed over (along with any associated CISs or eSCO connections). As shown by reference number 1810, the CCM 508 may transmit a complete handover message to the first controller 504, which responds with a command complete message. The first controller 504 may transmit disconnection complete messages for an eSCO, CISs, and/or an ACL.

The CCM 508 may complete the handover on the second controller 506. As shown by reference number 1812, the CCM 508 may transmit a request to the second controller to establish a connection with the user device 502 and to complete the handover. The second controller 506 may transmit synchronous connection complete and command complete (for ACL handle) messages. The CCM 508 may transmit a complete handover message to the second controller 506, as shown by reference number 1814. The second controller 506 may respond with a command complete message. The second controller 506 may start acknowledging (ACKing) packets and resume ACL traffic. On a BR/EDR ACL, the second controller 506 may also reenable the L2CAP flow.

As indicated above, FIGS. 18A-18B are provided as an example. Other examples may differ from what is described with regard to FIGS. 18A-18B.

FIGS. 19A-19C are diagrams illustrating an example 1900 of a CCM assisted handover, in accordance with the present disclosure.

In some aspects, the CCM 508 may assist a controller in handing over an LE or BR/EDR ACL connection and any associated connections (such as CISs and eSCO) from one controller to another, such as from the first controller 504 to the second controller 506. The first controller 504 in example 1900 of FIG. 19A may role switch and start the handover, similar to as described in connection with FIG. 18A.

Example 1900 continues in FIG. 19B with the start of mirroring, as shown by reference number 1902. This may include the exchange of shadow messages to maintain a logical connection while the physical connection is changing from the first controller 504 to the second controller 506. Messaging is shown for both BR/EDR and Bluetooth LE in FIG. 19B. For BR/EDR, the first controller 504 may request that the second controller 506 mirror the ACL and any associated eSCO connections. For LE, the first controller 504 may request that the second controller 506 mirror the ACL connection.

As shown by reference number 1904 in FIG. 19C, the first controller 504 and the second controller 506 may continue to communicate to perform the handover. The first controller 504 may transmit a handover request message (e.g., qualified LE media profile (QLMP) message, QLMP_eSCO_handover_req), and the second controller 506 may provide a response (e.g., QLMP_accepted). The first controller 504 may then transmit a disconnection complete message. For BR/EDR, this may be performed to handover the ACL, the eSCO, and any associated connections. For Bluetooth LE, the first controller 504 may hand over the ACL to the second controller 506 and delegate any associated CISs to the second controller 506.

The user device 502 may receive a first message from the first controller 504 (having a first wireless protocol address or a first Bluetooth address). Due to the handover, the user device 502 may receive a second message from the second controller 506 (having a second wireless protocol or a second Bluetooth address). The first wireless protocol and the second wireless protocol may be the same wireless protocol (e.g., same Bluetooth address). The user device 502 may observe the same single device address, same set of paired keys, and/or the same wireless protocol instance for the first controller device and the second controller device.

In some aspects, the second controller 506 may hand over the connection to a third controller, which may be a new controller or back to the first controller 504. The first controller 504 and the second controller 506 may have performed a handover operation between themselves or with the CCM 508 to connect to the third controller.

As indicated above, FIGS. 19A-19C are provided as an example. Other examples may differ from what is described with regard to FIGS. 19A-19C.

FIG. 20 is a diagram illustrating an example process 2000 performed, for example, at a first controller device or an apparatus of a first controller device, in accordance with the present disclosure. Example process 2000 is an example where the apparatus or the first controller device (e.g., first controller 504) performs operations associated with single controller interaction for a user device (e.g., UE).

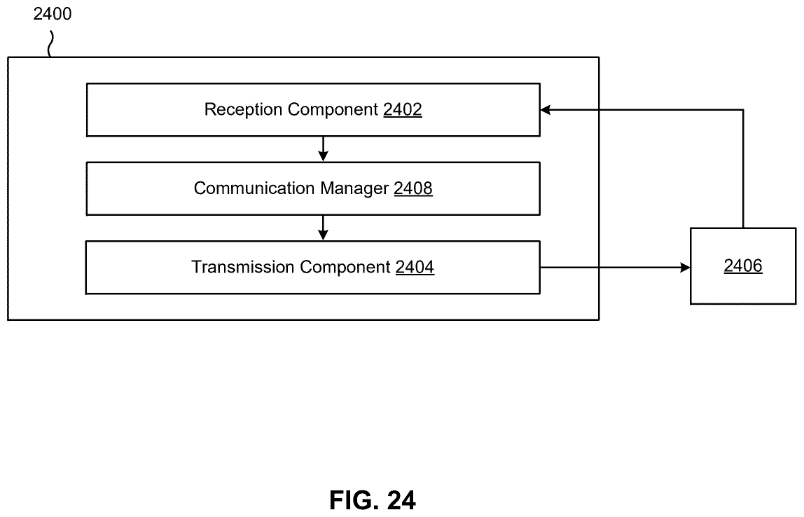

As shown in FIG. 20, in some aspects, process 2000 may include receiving a connection request from a UE (block 2010). For example, the first controller device (e.g., using reception component 2402 and/or communication manager 2406, depicted in FIG. 24) may receive a connection request from a UE, as described above.

As further shown in FIG. 20, in some aspects, process 2000 may include transmitting, to a central device, a connection message that indicates a connection or a potential connection between the first controller device and the UE (block 2020). For example, the first controller device (e.g., using transmission component 2404 and/or communication manager 2406, depicted in FIG. 24) may transmit, to a central device, a connection message that indicates a connection or a potential connection between the first controller device and the UE, as described above.

As further shown in FIG. 20, in some aspects, process 2000 may include receiving a first handover message from the central device (block 2030). For example, the first controller device (e.g., using reception component 2402 and/or communication manager 2406, depicted in FIG. 24) may receive a first handover message from the central device, as described above. The central device may be a CCM.

As further shown in FIG. 20, in some aspects, process 2000 may include performing a first handover of the UE to a second controller device based at least in part on the first handover message (block 2040). For example, the first controller device (e.g., using communication manager 2406, depicted in FIG. 24) may perform a first handover of the UE to a second controller device based at least in part on the first handover message, as described above.

Process 2000 may include additional aspects, such as any single aspect or any combination of aspects described below and/or in connection with one or more other processes described elsewhere herein.

In a first aspect, process 2000 includes receiving, from the central device, assistance with the first handover.

In a second aspect, alone or in combination with the first aspect, process 2000 includes receiving, from the second controller device, assistance with the first handover.

In a third aspect, alone or in combination with one or more of the first and second aspects, the central device is coupled to a vehicle.

In a fourth aspect, alone or in combination with one or more of the first through third aspects, process 2000 includes providing a single device address and a single set of keys to the UE on behalf of the first controller device and the second controller device.

In a fifth aspect, alone or in combination with one or more of the first through fourth aspects, process 2000 includes providing a single wireless protocol instance to the UE on behalf of the first controller device and the second controller device.

In a sixth aspect, alone or in combination with one or more of the first through fifth aspects, process 2000 includes performing a single wireless protocol pairing that applies to both the first controller device and the second controller device.

In a seventh aspect, alone or in combination with one or more of the first through sixth aspects, process 2000 includes receiving, from the central device, a message that indicates that the first controller device is to connect to the UE.

In an eighth aspect, alone or in combination with one or more of the first through seventh aspects, process 2000 includes performing channel sounding to obtain one or more of a direction of the UE or a distance between the UE and the first controller device, and transmitting, to the central device, an indication of the one or more of the direction of the UE or the distance.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, at a central device or an apparatus of a central device, in accordance with the present disclosure. Example process 2100 is an example where the apparatus or the central device (e.g., CCM 508) performs operations associated with single controller interaction for a user device (e.g., UE).

As shown in FIG. 21, in some aspects, process 2100 may include receiving, from a first controller device, a connection message that indicates a connection or a potential connection between the first controller device and a UE (block 2110). For example, the central device (e.g., using reception component 2402 and/or communication manager 2406, depicted in FIG. 24) may receive, from a first controller device, a connection message that indicates a connection or a potential connection between the first controller device and a UE, as described above.

As further shown in FIG. 21, in some aspects, process 2100 may include transmitting, to one or more of the first controller device or a second controller device, a handover message that indicates a handover of the UE from the first controller device to the second controller device (block 2120). For example, the central device (e.g., using transmission component 2404 and/or communication manager 2406, depicted in FIG. 24) may transmit, to one or more of the first controller device or a second controller device, a handover message that indicates a handover of the UE from the first controller device to the second controller device, as described above.

Process 2100 may include additional aspects, such as any single aspect or any combination of aspects described below and/or in connection with one or more other processes described elsewhere herein.

In a first aspect, process 2100 includes transmitting, to the first controller device, a message that indicates that the first controller device is to connect to the UE.

In a second aspect, alone or in combination with the first aspect, process 2100 includes determining to perform the handover based at least in part on a device type.

In a third aspect, alone or in combination with one or more of the first and second aspects, process 2100 includes selecting the second controller device based at least in part on a position of the UE.

In a fourth aspect, alone or in combination with one or more of the first through third aspects, process 2100 includes determining to perform the handover based at least in part on a bandwidth usage of the first controller device and an available bandwidth of the second controller device.

In a fifth aspect, alone or in combination with one or more of the first through fourth aspects, process 2100 includes transmitting, to one or more of the second controller device or a third controller device, a second handover message that indicates a second handover of the UE from the second controller device to the third controller device.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram illustrating an example process 2200 performed, for example, at a UE or an apparatus of a UE, in accordance with the present disclosure. Example process 2200 is an example where the apparatus or the UE (e.g., user device 502) performs operations associated with single controller interaction for a user device (e.g., UE).

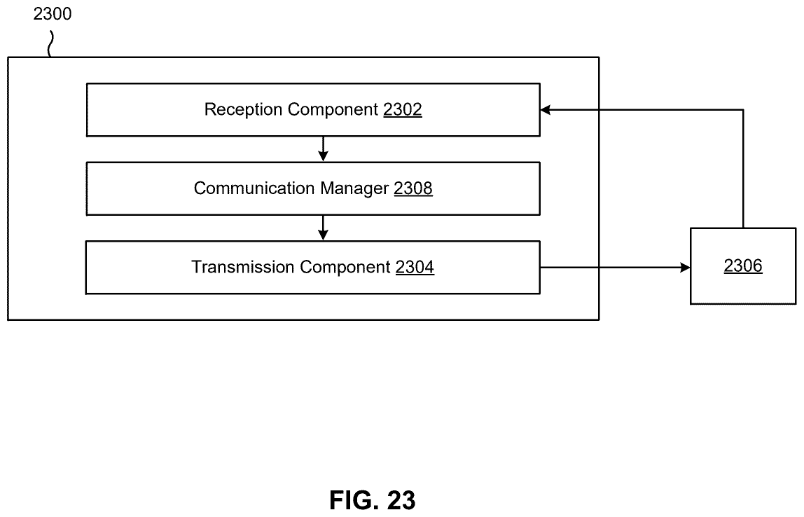

As shown in FIG. 22, in some aspects, process 2200 may include transmitting a connection request (block 2210). For example, the UE (e.g., using transmission component 2304 and/or communication manager 2306, depicted in FIG. 23) may transmit a connection request, as described above.

As further shown in FIG. 22, in some aspects, process 2200 may include receiving a first message from a first controller device having a first wireless protocol address (block 2220). For example, the UE (e.g., using reception component 2302 and/or communication manager 2306, depicted in FIG. 23) may receive a first message from a first controller device having a first wireless protocol address, as described above.

As further shown in FIG. 22, in some aspects, process 2200 may include receiving a second message from a second controller device having a second wireless protocol address, wherein the first wireless protocol address and the second wireless protocol address are a same address (block 2230). For example, the UE (e.g., using reception component 2302 and/or communication manager 2306, depicted in FIG. 23) may receive a second message from a second controller device having a second wireless protocol address, wherein the first wireless protocol address and the second wireless protocol address are a same address, as described above.

Process 2200 may include additional aspects, such as any single aspect or any combination of aspects described below and/or in connection with one or more other processes described elsewhere herein.

In a first aspect, process 2200 includes receiving a wireless protocol paired list that shows a single device address for the first controller device and the second controller device.

In a second aspect, alone or in combination with the first aspect, process 2200 includes using a single set of paired keys for the first controller device and the second controller device.

In a third aspect, alone or in combination with one or more of the first and second aspects, process 2200 includes displaying a single wireless protocol instance for the first controller device and the second controller device.

In a fourth aspect, alone or in combination with one or more of the first through third aspects, transmitting the connection request includes transmitting the connection request within a vehicle.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

FIG. 23 is a diagram of an example apparatus 2300 for wireless communication, in accordance with the present disclosure. The apparatus 2300 may be a UE, or a UE may include the apparatus 2300. In some aspects, the apparatus 2300 includes a reception component 2302, a transmission component 2304, and/or a communication manager 2306, which may be in communication with one another (for example, via one or more buses and/or one or more other components). In some aspects, the communication manager 2306 is the communication manager 150 described in connection with FIG. 1. As shown, the apparatus 2300 may communicate with another apparatus 2308, such as a UE or a network node (such as a CU, a DU, an RU, or a base station), using the reception component 2302 and the transmission component 2304. The communication manager 2306 may be included in, or implemented via, a processing system (for example, the components of the wireless communication device 300 described in connection with FIG. 3) of the UE.

In some aspects, the apparatus 2300 may be configured to perform one or more operations described herein in connection with FIGS. 1-19C. Additionally, or alternatively, the apparatus 2300 may be configured to perform one or more processes described herein, such as process 2200 of FIG. 22. In some aspects, the apparatus 2300 and/or one or more components shown in FIG. 23 may include one or more components of the UE described in connection with FIG. 1. Additionally, or alternatively, one or more components shown in FIG. 23 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications, and may provide the processed signals to the one or more other components of the apparatus 2300. In some aspects, the reception component 2302 may include one or more components of the UE described above in connection with FIG. 1, such as a radio, one or more RF chains, one or more transceivers, or one or more modems, each of which may in turn be coupled with one or more antennas of the UE.

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications, and may transmit the processed signals to the apparatus 2308. In some aspects, the transmission component 2304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 2304 may be co-located with the reception component 2302.

The communication manager 2306 may support operations of the reception component 2302 and/or the transmission component 2304. For example, the communication manager 2306 may receive information associated with configuring reception of communications by the reception component 2302 and/or transmission of communications by the transmission component 2304. Additionally, or alternatively, the communication manager 2306 may generate and/or provide control information to the reception component 2302 and/or the transmission component 2304 to control reception and/or transmission of communications.

In some aspects associated with a user device, the transmission component 2304 may transmit a connection request. The reception component 2302 may receive a first message from a first controller device having a first wireless protocol address. The reception component 2302 may receive a second message from a second controller device having a second wireless protocol address, where the first wireless protocol address and the second wireless protocol address are a same address.

The reception component 2302 may receive a wireless protocol paired list that shows a single device address for the first controller device and the second controller device. The communication manager 2306 may use a single set of paired keys for the first controller device and the second controller device. The communication manager 2306 may display a single wireless protocol instance for the first controller device and the second controller device.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

FIG. 24 is a diagram of an example apparatus 2400 for wireless communication, in accordance with the present disclosure. The apparatus 2400 may be a first controller device, or a first controller device may include the apparatus 2400. In some aspects, the apparatus 2400 includes a reception component 2402, a transmission component 2404, and/or a communication manager 2406, which may be in communication with one another (for example, via one or more buses and/or one or more other components). In some aspects, the communication manager 2406 is the communication manager 150 described in connection with FIG. 1. As shown, the apparatus 2400 may communicate with another apparatus 2408, such as a UE or a network node (such as a CU, a DU, an RU, or a base station), using the reception component 2402 and the transmission component 2404. The communication manager 2406 may be included in, or implemented via, a processing system (for example, the components of the wireless communication device 300 described in connection with FIG. 3) of the first controller device.

In some aspects, the apparatus 2400 may be configured to perform one or more operations described herein in connection with FIGS. 1-19C. Additionally, or alternatively, the apparatus 2400 may be configured to perform one or more processes described herein, such as process 2000 of FIG. 20, process 2100 of FIG. 21, or a combination thereof. In some aspects, the apparatus 2400 and/or one or more components shown in FIG. 24 may include one or more components of the first controller device described in connection with FIG. 1. Additionally, or alternatively, one or more components shown in FIG. 24 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2402 may receive communications, such as reference signals, control information, data communications, or a combination thereof, from the apparatus 2408. The reception component 2402 may provide received communications to one or more other components of the apparatus 2400. In some aspects, the reception component 2402 may perform signal processing on the received communications, and may provide the processed signals to the one or more other components of the apparatus 2400. In some aspects, the reception component 2402 may include one or more components of the first controller device described above in connection with FIG. 1, such as a radio, one or more RF chains, one or more transceivers, or one or more modems, each of which may in turn be coupled with one or more antennas of the first controller device.

The transmission component 2404 may transmit communications, such as reference signals, control information, data communications, or a combination thereof, to the apparatus 2408. In some aspects, one or more other components of the apparatus 2400 may generate communications and may provide the generated communications to the transmission component 2404 for transmission to the apparatus 2408. In some aspects, the transmission component 2404 may perform signal processing on the generated communications, and may transmit the processed signals to the apparatus 2408. In some aspects, the transmission component 2404 may include one or more components of the first controller device described above in connection with FIG. 1, such as a radio, one or more RF chains, one or more transceivers, or one or more modems, each of which may in turn be coupled with one or more antennas of the first controller device described in connection with FIG. 1. In some aspects, the transmission component 2404 may be co-located with the reception component 2402.

The communication manager 2406 may support operations of the reception component 2402 and/or the transmission component 2404. For example, the communication manager 2406 may receive information associated with configuring reception of communications by the reception component 2402 and/or transmission of communications by the transmission component 2404. Additionally, or alternatively, the communication manager 2406 may generate and/or provide control information to the reception component 2402 and/or the transmission component 2404 to control reception and/or transmission of communications.

In some aspects associated with a first controller device, the reception component 2402 may receive a connection request from a UE. The transmission component 2404 may transmit, to a central device, a connection message that indicates a connection or a potential connection between the first controller device and the UE. The reception component 2402 may receive a first handover message from the central device. The communication manager 2406 may perform a first handover of the UE to a second controller device based at least in part on the first handover message.

The reception component 2402 may receive, from the central device, assistance with the first handover. The reception component 2402 may receive, from the second controller device, assistance with the first handover.

The communication manager 2406 may provide a single device address and a single set of keys to the UE on behalf of the first controller device and the second controller device. The communication manager 2406 may provide a single wireless protocol instance to the UE on behalf of the first controller device and the second controller device. The communication manager 2406 may perform a single wireless protocol pairing that applies to both the first controller device and the second controller device.

The reception component 2402 may receive, from the central device, a message that indicates that the first controller device is to connect to the UE. The communication manager 2406 may perform channel sounding to obtain one or more of a direction of the UE or a distance between the UE and the first controller device. The transmission component 2404 may transmit, to the central device, an indication of the one or more of the direction of the UE or the distance.

In some aspects associated with a central device (e.g., CCM), the reception component 2402 may receive, from a first controller device, a connection message that indicates a connection or a potential connection between the first controller device and a UE. The transmission component 2404 may transmit, to one or more of the first controller device or a second controller device, a handover message that indicates a handover of the UE from the first controller device to the second controller device.

The transmission component 2404 may transmit, to the first controller device, a message that indicates that the first controller device is to connect to the UE. The communication manager 2406 may determine to perform the handover based at least in part on a device type. The communication manager 2406 may select the second controller device based at least in part on a position of the UE. The communication manager 2406 may determine to perform the handover based at least in part on a bandwidth usage of the first controller device and an available bandwidth of the second controller device.

The transmission component 2404 may transmit, to one or more of the second controller device or a third controller device, a second handover message that indicates a second handover of the UE from the second controller device to the third controller device.

The number and arrangement of components shown in FIG. 24 are provided as an example. In practice, there may be additional components, fewer components, different components, or differently arranged components than those shown in FIG. 24. Furthermore, two or more components shown in FIG. 24 may be implemented within a single component, or a single component shown in FIG. 24 may be implemented as multiple, distributed components. Additionally, or alternatively, a set of (one or more) components shown in FIG. 24 may perform one or more functions described as being performed by another set of components shown in FIG. 24.

The following provides an overview of some Aspects of the present disclosure:

Aspect 1: A method of wireless communication performed by a first controller device, comprising: receiving a connection request from a user equipment (UE); transmitting, to a central device, a connection message that indicates a connection or a potential connection between the first controller device and the UE; receiving a first handover message from the central device; and performing a first handover of the UE to a second controller device based at least in part on the first handover message.

Aspect 2: The method of Aspect 1, further comprising receiving, from the central device, assistance with the first handover.

Aspect 3: The method of any of Aspects 1-2, further comprising receiving, from the second controller device, assistance with the first handover.

Aspect 4: The method of any of Aspects 1-3, wherein the central device is coupled to a vehicle.

Aspect 5: The method of any of Aspects 1-4, further comprising providing a single device address and a single set of keys to the UE on behalf of the first controller device and the second controller device.

Aspect 6: The method of any of Aspects 1-5, further comprising providing a single wireless protocol instance to the UE on behalf of the first controller device and the second controller device.

Aspect 7: The method of any of Aspects 1-6, further comprising performing a single wireless protocol pairing that applies to both the first controller device and the second controller device.

Aspect 8: The method of any of Aspects 1-7, further comprising receiving, from the central device, a message that indicates that the first controller device is to connect to the UE.

Aspect 9: The method of any of Aspects 1-8, further comprising: performing channel sounding to obtain one or more of a direction of the UE or a distance between the UE and the first controller device; and transmitting, to the central device, an indication of the one or more of the direction of the UE or the distance.

Aspect 10: A method of wireless communication performed by a central device, comprising: receiving, from a first controller device, a connection message that indicates a connection or a potential connection between the first controller device and a user equipment (UE); and transmitting, to one or more of the first controller device or a second controller device, a handover message that indicates a handover of the UE from the first controller device to the second controller device.

Aspect 11: The method of Aspect 10, further comprising transmitting, to the first controller device, a message that indicates that the first controller device is to connect to the UE.

Aspect 12: The method of any of Aspects 10-11, further comprising determining to perform the handover based at least in part on a device type.

Aspect 13: The method of any of Aspects 10-12, further comprising selecting the second controller device based at least in part on a position of the UE.

Aspect 14: The method of any of Aspects 10-13, further comprising determining to perform the handover based at least in part on a bandwidth usage of the first controller device and an available bandwidth of the second controller device.

Aspect 15: The method of any of Aspects 10-14, further comprising transmitting, to one or more of the second controller device or a third controller device, a second handover message that indicates a second handover of the UE from the second controller device to the third controller device.

Aspect 16: A method of wireless communication performed by a user equipment (UE), comprising: transmitting a connection request; receiving a first message from a first controller device having a first wireless protocol address; and receiving a second message from a second controller device having a second wireless protocol address, wherein the first wireless protocol address and the second wireless protocol address are a same address.

Aspect 17: The method of Aspect 16, further comprising receiving a wireless protocol paired list that shows a single device address for the first controller device and the second controller device.

Aspect 18: The method of any of Aspects 16-17, further comprising using a single set of paired keys for the first controller device and the second controller device.

Aspect 19: The method of any of Aspects 16-18, further comprising displaying a single wireless protocol instance for the first controller device and the second controller device.

Aspect 20: The method of any of Aspects 16-19, wherein transmitting the connection request includes transmitting the connection request within a vehicle.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, the phrase “based on” is intended to mean “based at least in part on” or “based on or otherwise in association with” unless explicitly stated otherwise.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first controller device, comprising:
one or more memories; and
one or more processors coupled to the one or more memories, the one or more processors individually or collectively configured to cause the first controller device to:
receive a connection request from a user equipment (UE);
transmit, to a central device, a connection message that indicates a connection or a potential connection between the first controller device and the UE;
receive a first handover message from the central device; and
perform a first handover of the UE to a second controller device based at least in part on the first handover message.

2. The apparatus of claim 1, wherein the one or more processors are individually or collectively configured to cause the first controller device to receive, from the central device, assistance with the first handover.

3. The apparatus of claim 1, wherein the one or more processors are individually or collectively configured to cause the first controller device to receive, from the second controller device, assistance with the first handover.

4. The apparatus of claim 1, wherein the central device is coupled to a vehicle.

5. The apparatus of claim 1, wherein the one or more processors are individually or collectively configured to cause the first controller device to provide a single device address and a single set of keys to the UE on behalf of the first controller device and the second controller device.

6. The apparatus of claim 1, wherein the one or more processors are individually or collectively configured to cause the first controller device to provide a single wireless protocol instance to the UE on behalf of the first controller device and the second controller device.

7. The apparatus of claim 1, wherein the one or more processors are individually or collectively configured to cause the first controller device to perform a single wireless protocol pairing that applies to both the first controller device and the second controller device.

8. The apparatus of claim 1, wherein the one or more processors are individually or collectively configured to cause the first controller device to receive, from the central device, a message that indicates that the first controller device is to connect to the UE.

9. The apparatus of claim 1, wherein the one or more processors are individually or collectively configured to cause the first controller device to:
perform channel sounding to obtain one or more of a direction of the UE or a distance between the UE and the first controller device; and
transmit, to the central device, an indication of the one or more of the direction of the UE or the distance.

10. An apparatus for wireless communication at a central device, comprising:
one or more memories; and
one or more processors coupled to the one or more memories, the one or more processors individually or collectively configured to cause the central device to:
receive, from a first controller device, a connection message that indicates a connection or a potential connection between the first controller device and a user equipment (UE); and
transmit, to one or more of the first controller device or a second controller device, a handover message that indicates a handover of the UE from the first controller device to the second controller device.

11. The apparatus of claim 10, wherein the one or more processors are individually or collectively configured to cause the central device to transmit, to the first controller device, a message that indicates that the first controller device is to connect to the UE.

12. The apparatus of claim 10, wherein the one or more processors are individually or collectively configured to cause the central device to determine to perform the handover based at least in part on a device type.

13. The apparatus of claim 10, wherein the one or more processors are individually or collectively configured to cause the central device to select the second controller device based at least in part on a position of the UE.

14. The apparatus of claim 10, wherein the one or more processors are individually or collectively configured to cause the central device to determine to perform the handover based at least in part on a bandwidth usage of the first controller device and an available bandwidth of the second controller device.

15. The apparatus of claim 10, wherein the one or more processors are individually or collectively configured to cause the central device to transmit, to one or more of the second controller device or a third controller device, a second handover message that indicates a second handover of the UE from the second controller device to the third controller device.

16. An apparatus for wireless communication at a user equipment (UE), comprising:
one or more memories; and
one or more processors coupled to the one or more memories, the one or more processors individually or collectively configured to cause the UE to:
transmit a connection request;
receive a first message from a first controller device having a first wireless protocol address; and
receive a second message from a second controller device having a second wireless protocol address, wherein the first wireless protocol address and the second wireless protocol address are a same address.

17. The apparatus of claim 16, wherein the one or more processors are individually or collectively configured to cause the UE to receive a wireless protocol paired list that shows a single device address for the first controller device and the second controller device.

18. The apparatus of claim 16, wherein the one or more processors are individually or collectively configured to cause the UE to use a single set of paired keys for the first controller device and the second controller device.

19. The apparatus of claim 16, wherein the one or more processors are individually or collectively configured to cause the UE to display a single wireless protocol instance for the first controller device and the second controller device.

20. The apparatus of claim 16, wherein to transmit the connection request, the one or more processors are individually or collectively configured to cause the UE to transmit the connection request within a vehicle.
